(19) United States
(12) Patent Application Publication
(10) Pub. No.: US 2026/0162461 A1
(43) Pub. Date: Jun. 11, 2026

(54) SYSTEMS AND METHODS FOR IMPROVED MULTIMODAL GESTURE RECOGNITION, ARTIFICIAL INTELLIGENCE CONTINUOUS ACTIVITY TRACKING SCANNER FOR REAL TIME RENDERING OF LANGUAGE MODELS THOUGHTS, USING A MODEL FOR COMPUTER CODE REVIEW & MACHINE LEARNING MODELS ASSOCIATED WITH CUSTOMER SURVEYS

(71) Applicant: Meta Platforms, Inc., Menlo Park, CA (US)

(72) Inventors: Chuan Qin, Bellevue, WA (US); Saurabh Sharma, Snohomish, WA (US); Samuel Alston, Manhattan, NY (US); Trupti Balekundri, Pleasanton, CA (US); Stefan Scherer, Studio City, CA (US); Akshat Akshat, Seattle, WA (US); Nikhil Kumar, Mountlake Terrace, WA (US); Shivam Anand, Seattle, WA (US)

(21) Appl. No.: 19/409,458

(22) Filed: Dec. 4, 2025

Related U.S. Application Data
(60) Provisional application No. 63/728,909, filed on Dec. 6, 2024.
(60) Provisional application No. 63/734,911, filed on Dec. 17, 2024.
(60) Provisional application No. 63/740,897, filed on Dec. 31, 2024.
(60) Provisional application No. 63/740,913, filed on Dec. 31, 2024.

(51) Int. Cl. G06V 40/20; G06Q 30/0203

(52) U.S. Cl. CPC G06V 40/20; G06Q 30/0203

(57) ABSTRACT

A method for improved multimodal gesture recognition may include training a first model to recognize a gesture in a first input modality and using the training of the first model to recognize the gesture in the first input modality to train a second model in a second input modality to recognize the gesture.

### CROSS-REFERENCE TO RELATED APPLICATIONS

This application claims priority to U.S. Provisional Application No. 63/728,909, filed Dec. 6, 2024, entitled “Systems And Methods For Improved Multimode Gesture Recognition,” and U.S. Provisional Application No. 63/734,911, filed Dec. 17, 2024, entitled “Artificial Intelligence Continuous Activity Tracking (AI CAT) Scanner For Realtime Rendering of Language Models Thoughts” and U.S. Provisional Application No. 63/740,897, filed Dec. 31, 2024 entitled “Using A Model For Computer Code Review” and U.S. Provisional Application No. 63/740,913, filed Dec. 31, 2024 entitled “Machine Learning Models Associated With Customer Surveys”, each of which are incorporated by reference herein in their entirety.

### BRIEF DESCRIPTION OF DRAWINGS

The accompanying drawings illustrate a number of exemplary embodiments and are a part of the specification. Together with the following description, these drawings demonstrate and explain various principles of the present disclosure.

FIG. 1 is an illustration of an example artificial-reality system according to some embodiments of this disclosure.

FIG. 2 is an illustration of an example artificial-reality system with a handheld device according to some embodiments of this disclosure.

FIG. 3A is an illustration of example user interactions within an artificial-reality system according to some embodiments of this disclosure.

FIG. 3B is an illustration of example user interactions within an artificial-reality system according to some embodiments of this disclosure.

FIG. 4A is an illustration of example user interactions within an artificial-reality system according to some embodiments of this disclosure.

FIG. 4B is an illustration of example user interactions within an artificial-reality system according to some embodiments of this disclosure.

FIG. 5 is an illustration of an example wrist-wearable device of an artificial-reality system according to some embodiments of this disclosure.

FIG. 6 is an illustration of an example wearable artificial-reality system according to some embodiments of this disclosure.

FIG. 7 is an illustration of an example augmented-reality system according to some embodiments of this disclosure.

FIG. 8A is an illustration of an example virtual-reality system according to some embodiments of this disclosure.

FIG. 8B is an illustration of another perspective of the virtual-reality systems shown in FIG. 8A.

FIG. 9 is a block diagram showing system components of example artificial- and virtual-reality systems.

FIG. 10A illustrates an example system for AI CAT scanning.

FIG. 10B illustrates an example system for AI CAT scanning.

FIG. 11A illustrates an example visualization system associated with a radar graph.

FIG. 11B illustrates an example visualization system associated with a radar graph.

FIG. 12 illustrates an example method for visualizing artificial intelligence (AI) operations.

FIG. 13 illustrates an example method for visualizing artificial intelligence operations.

FIG. 14 illustrates an example block diagram of an exemplary computing device suitable for implementing aspects of the disclosed subject matter.

FIG. 15 illustrates an example block diagram of an exemplary machine learning architecture for implementing aspects of the disclosed subject matter.

FIG. 16 illustrates an example of computer code, in accordance with aspects of the present disclosure.

FIG. 17 illustrates a flowchart showing a process for generating suggestions for diff review, in accordance with aspects of the present disclosure.

FIG. 18 illustrates a flowchart showing a process for managing diff review, in accordance with aspects of the present disclosure.

FIG. 19 illustrates an example of an output from a model, in accordance with aspects of the present disclosure.

FIG. 20 illustrates an example flowchart showing a process for diff review of computer code, in accordance with aspects of the present disclosure.

FIG. 21 illustrates an example of a machine learning framework including machine translation model and training database, in accordance with one or more examples of the present disclosure.

FIG. 22 illustrates a block diagram of a system for providing suggestions to diff code, in accordance with aspects of the present disclosure.

FIG. 23A illustrates an exemplary system for selective delivery of surveys to user accounts.

FIG. 23B illustrates an exemplary system for selection of user accounts to which the survey would pertain most.

FIG. 23C illustrates an exemplary machine learning model.

FIG. 24A is an example method for processing and delivering surveys from a server perspective.

FIG. 24B is an example method for the training, sampling, and calibrating processes required by the machine learning model to optimize the outreach of the survey.

FIG. 25 illustrates an example block diagram of an exemplary computing device suitable for the context of machine learning.

FIG. 26 illustrates an example block diagram of an exemplary computing device suitable for implementing aspects of the disclosed subject matter.

FIG. 27 illustrates an example block diagram of an exemplary computing device suitable for the context of artificial intelligence.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within this disclosure.

### DETAILED DESCRIPTION

### A. Methods for Improved Multimodal Gesture Recognition

The present disclosure is generally directed to a training process designed to capture user gestures by utilizing different input modalities. Input modalities may include a single channel of input or output between a user and computer-implemented device (e.g., vision-based and Electromyography-based modality (EMG-based modality)). The systems and methods described herein may compare features of training data from the input modalities to enable consistent gesture recognition. Further, models (e.g., a machine learning model using visual data and/or electrical signals for its operations) representing the input modalities may be trained through contrastive learning to enable dynamic user gesture recognition across multiple input modalities.

In one example, the disclosed systems and methods for improved multimodal gesture recognition may include training a first model to recognize a gesture in a first input modality. In some examples, a vision-based model may be trained using visual data (e.g., captured images, captured vision signals, video of user gestures, etc.), where the model processes the visual data to generate a feature vector, representing specific gestures. Training the vision-based model in this way may include techniques such as supervised learning, where the model may learn to correlate visual inputs with corresponding gestures. A second model (e.g., EMG-based model) may be trained using the training knowledge from the first model that operates in a second input modality (i.e., an EMG-based modality). The EMG-based model may be designed to interpret electrical signals generated by user muscle movements during the performance of gestures, and training the EMG-based model may include comparing the feature vectors generated by the vision-based model with those from the EMG-based model. For example, comparing the generated feature vectors may include using a loss function to align the gestures from different modalities. In some embodiments, using the learned gestures from the vision-based model may guide the training of the EMG-based model, enabling the EMG-based model to recognize the same learned gestures.

In some embodiments, a contrastive training method may be used to train both the vision-based and EMG-based models individually and/or simultaneously, such that the generated features for each gesture are aligned in a shared representation space. In some examples, the contrastive training method may enable users to customize gestures, where the customized gestures may be immediately recognizable across multiple input modalities. For example, methods include using captured visual data of user gestures to construct features and saving the constructed features via the vision-based model. For example, EMG data may be processed using the saved features from the vision-based model to generate representations for both the user and the EMG-based input modality. For example, the saved features from the visual data may be compared with the corresponding gestures captured through an EMG-based input modality. In further examples, the contrastive training method may personalize the disclosed systems (e.g., gesture recognition systems) for individual users by updating the EMG-based model using a vision-based model. Updating the EMG-based model in this way may enable dynamic gesture recognition across multiple modalities. In some examples, it may be advantageous to allow a harder-to-train modality (e.g., EMG-based modality) to be updated using an easier-to-train modality (vision-based modality). In some examples, a vision-based model may be updated based on the training knowledge from the EMG-based modality. In some examples, gesture recognition models for additional sensors (e.g., Inertial Measurement Unit (IMU), radar, etc.) may be updated based on training knowledge from various input modalities (e.g., vision-based modality, EMG-based modality, etc.) and vice versa.

In some embodiments, personalizing the gesture recognition system for individual users may further include fine-tuning the EMG model using a trained vision-based model. This fine-tuning process may include methods such as backpropagation to enable an EMG model to accurately recognize gestures in instances where there are variances in the EMG-based data used to generate the EMG-based model.

The disclosed multimodal gesture recognition may include training processes that correlate different modality inputs, reducing user training time and enhancing gesture recognition accuracy across modalities. By leveraging vision-based training to update EMG models and employing contrastive training techniques, the disclosed systems may offer improved multimodal gesture recognition systems.

Embodiments of the present disclosure may include or be implemented in conjunction with various types of Artificial-Reality (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed- or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

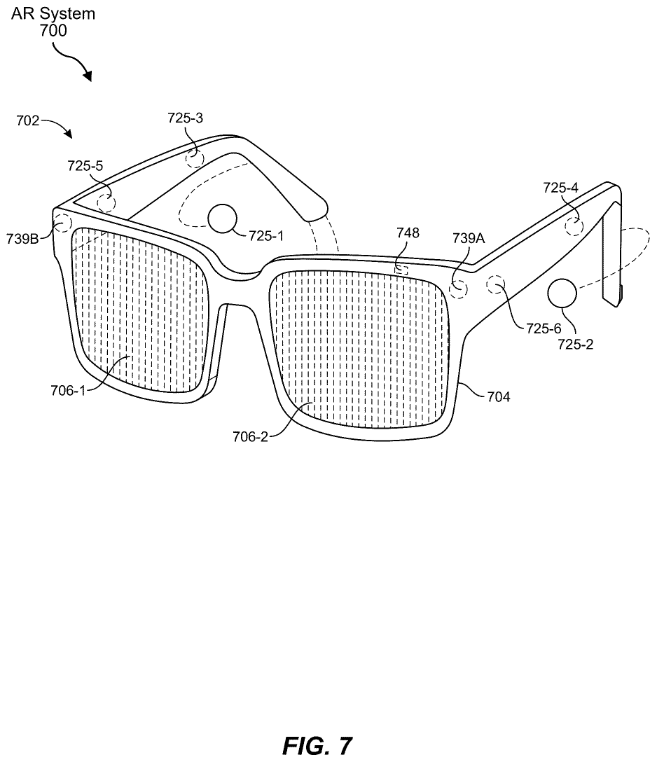

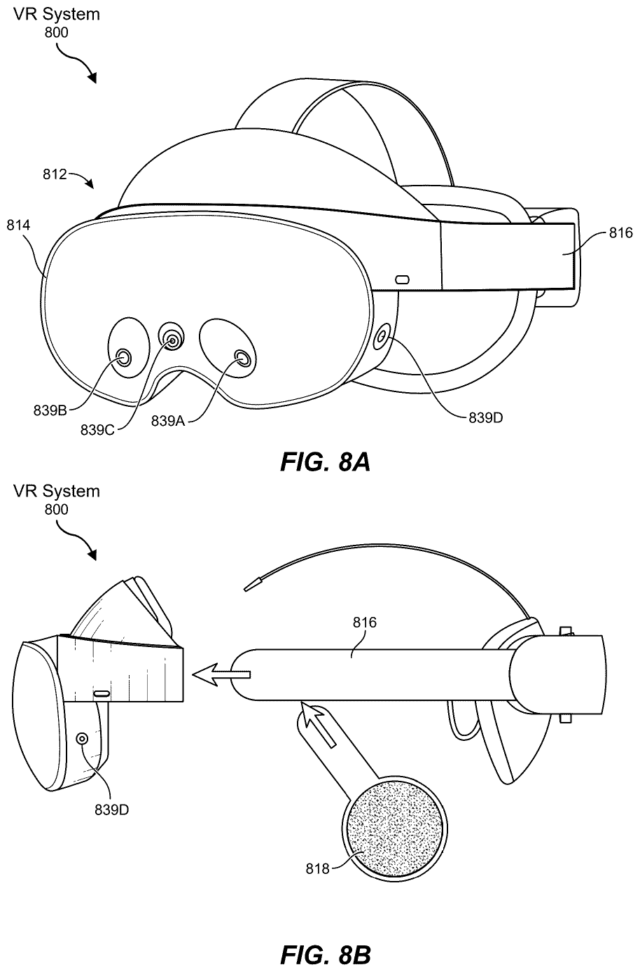

AR systems may be implemented in a variety of different form factors and configurations. Some AR systems may be designed to work without near-eye displays (NEDs). Other AR systems may include a NED that also provides visibility into the real world (such as, e.g., augmented-reality system 700 in FIG. 7) or that visually immerses a user in an artificial reality (such as, e.g., virtual-reality system 800 in FIGS. 8A and 8B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

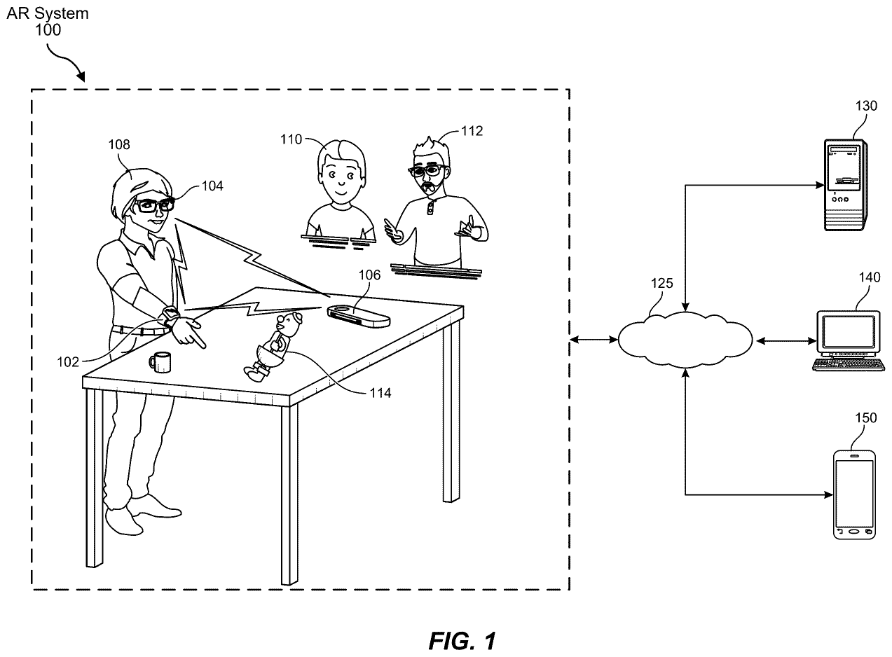

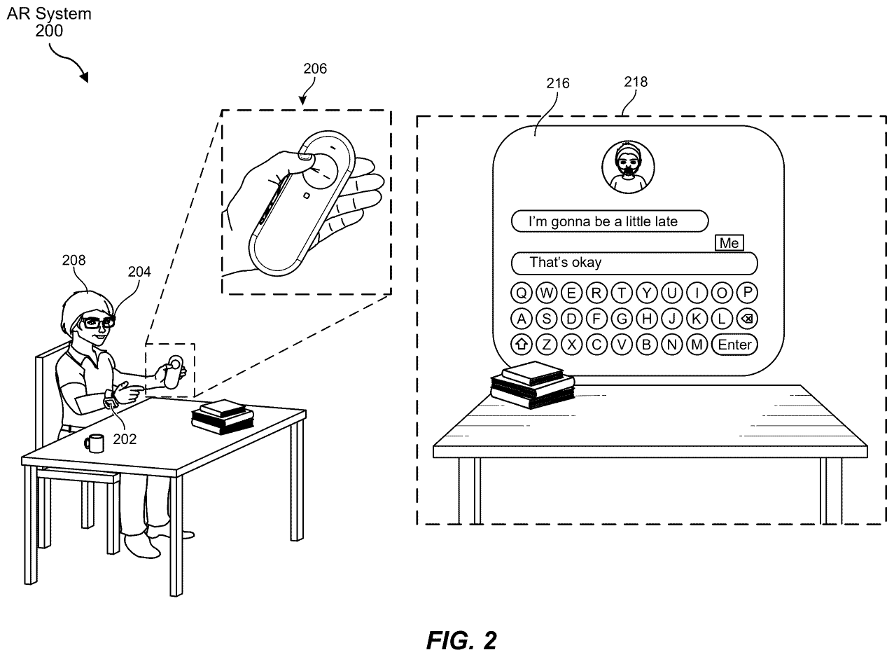

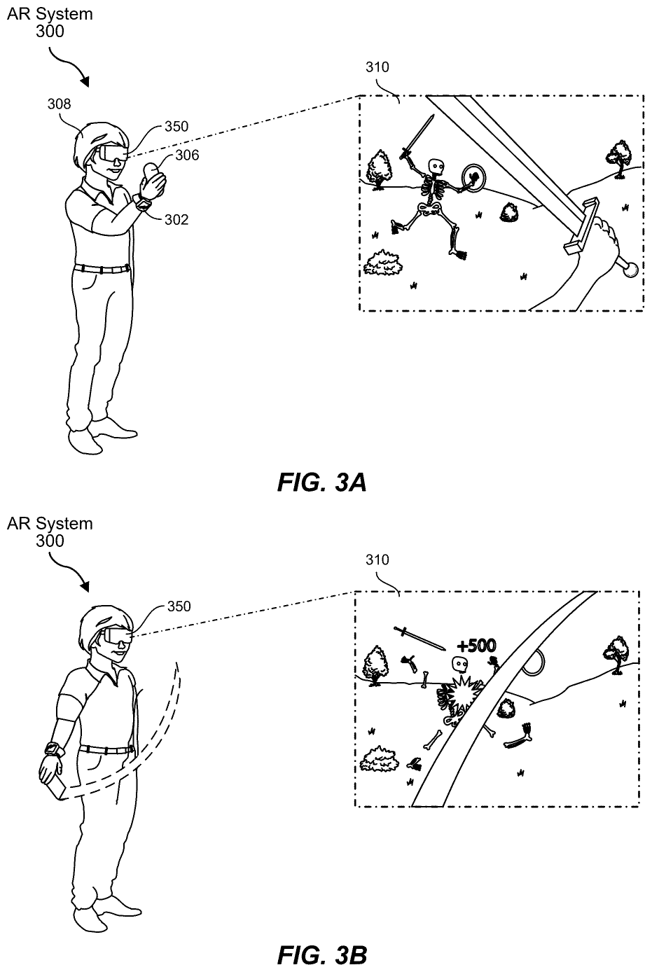

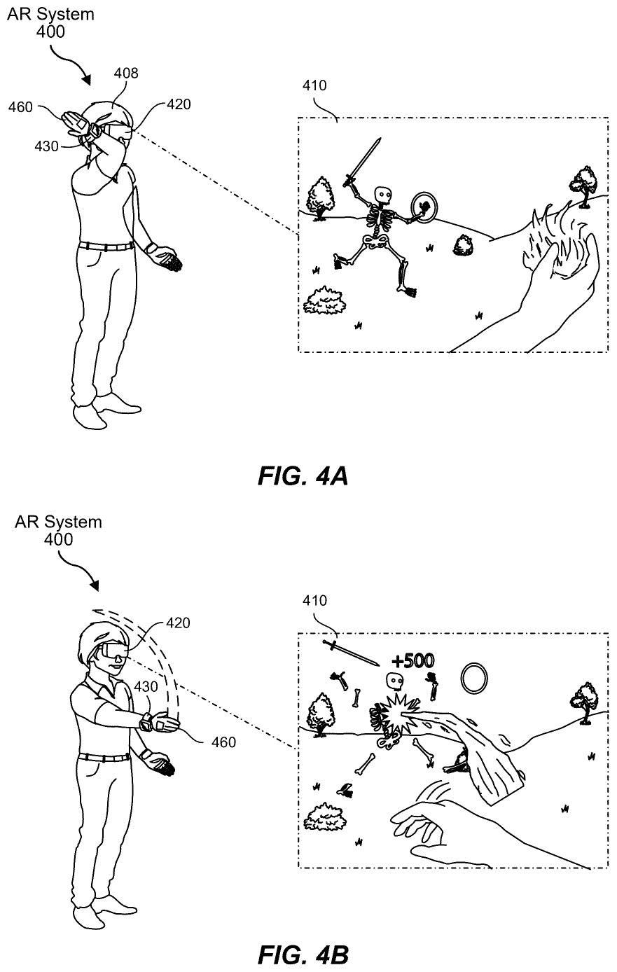

FIGS. 1, 2, 3A, 3B, 4A and 4B illustrate example artificial-reality (AR) systems in accordance with some embodiments. FIG. 1 shows a first AR system 100 and first example user interactions using a wrist-wearable device 102, a head-wearable device (e.g., AR glasses 700), and/or a handheld intermediary processing device (HIPD) 106. FIG. 2 shows a second AR system 200 and second example user interactions using a wrist-wearable device 202, AR glasses 204, and/or an HIPD 206. FIGS. 3A and 3B show a third AR system 300 and third example user 308 interactions using a wrist-wearable device 302, a head-wearable device (e.g., VR headset 350), and/or an HIPD 306. FIGS. 4A and 4B show a fourth AR system 400 and fourth example user 408 interactions using a wrist-wearable device 430, VR headset 420, and/or a haptic device 460 (e.g., wearable gloves).

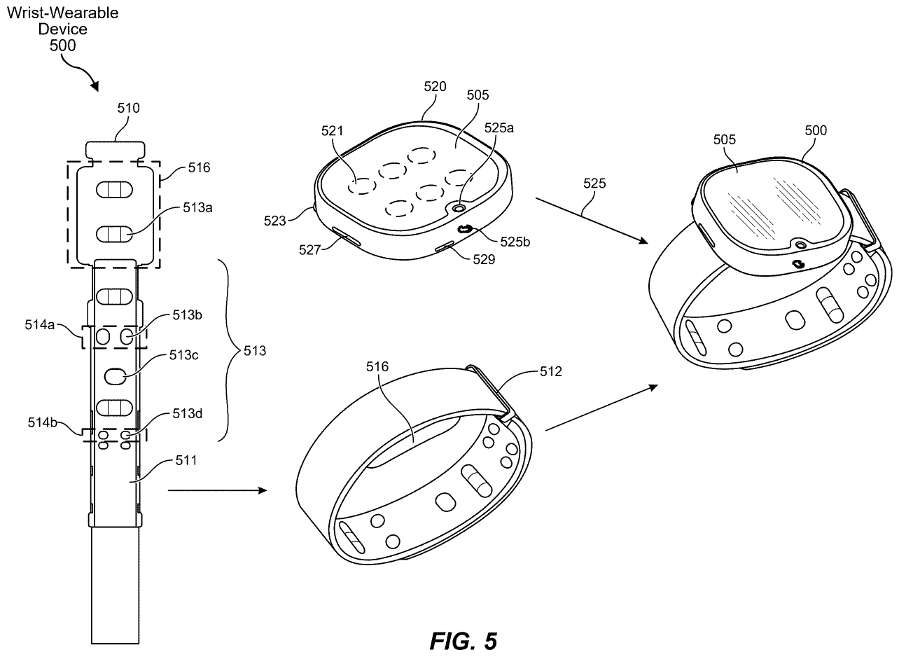

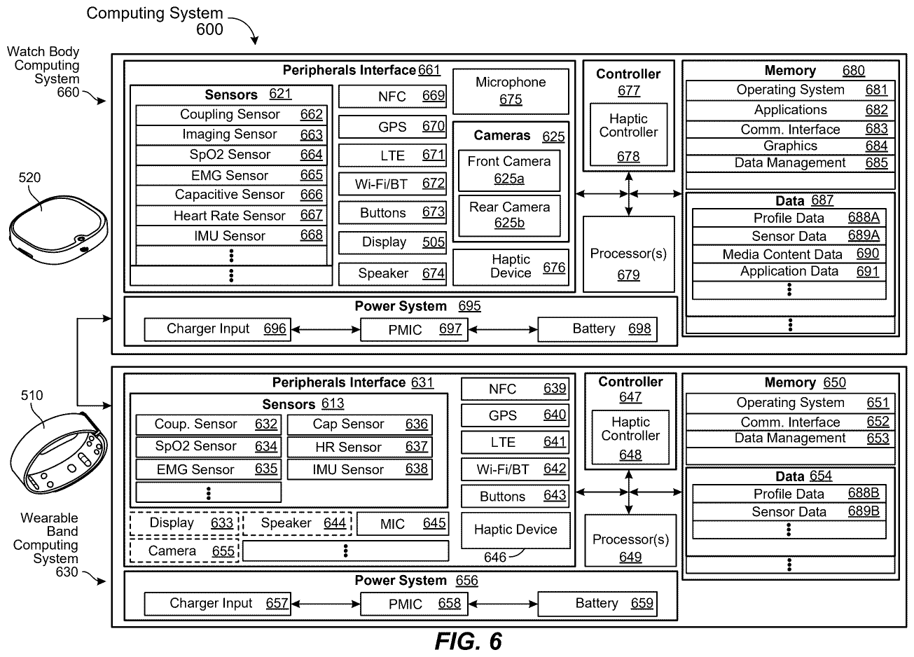

A wrist-wearable device 500, which can be used for wrist-wearable device 102, 202, 302, 430, and one or more of its components, are described below in reference to FIGS. 5 and 6; head-wearable devices 700 and 800, which can respectively be used for AR glasses 104, 204 or VR headset 350, 420, and their one or more components are described below in reference to FIGS. 7-9.

Referring to FIG. 1, wrist-wearable device 102, AR glasses 104, and/or HIPD 106 can communicatively couple via a network 125 (e.g., cellular, near field, Wi-Fi, personal area network, wireless LAN, etc.). Additionally, wrist-wearable device 102, AR glasses 104, and/or HIPD 106 can also communicatively couple with one or more servers 130, computers 140 (e.g., laptops, computers, etc.), mobile devices 150 (e.g., smartphones, tablets, etc.), and/or other electronic devices via network 125 (e.g., cellular, near field, Wi-Fi, personal area network, wireless LAN, etc.).

In FIG. 1, a user 108 is shown wearing wrist-wearable device 102 and AR glasses 104 and having HIPD 106 on their desk. The wrist-wearable device 102, AR glasses 104, and HIPD 106 facilitate user interaction with an AR environment. In particular, as shown by first AR system 100, wrist-wearable device 102, AR glasses 104, and/or HIPD 106 cause presentation of one or more avatars 110, digital representations of contacts 112, and virtual objects 114. As discussed below, user 108 can interact with one or more avatars 110, digital representations of contacts 112, and virtual objects 114 via wrist-wearable device 102, AR glasses 104, and/or HIPD 106.

User 108 can use any of wrist-wearable device 102, AR glasses 104, and/or HIPD 106 to provide user inputs. For example, user 108 can perform one or more hand gestures that are detected by wrist-wearable device 102 (e.g., using one or more EMG sensors and/or IMUs, described below in reference to FIGS. 5 and 6) and/or AR glasses 104 (e.g., using one or more image sensor or camera, described below in reference to FIGS. 7-10) to provide a user input. Alternatively, or additionally, user 108 can provide a user input via one or more touch surfaces of wrist-wearable device 102, AR glasses 104, HIPD 106, and/or voice commands captured by a microphone of wrist-wearable device 102, AR glasses 104, and/or HIPD 106. In some embodiments, wrist-wearable device 102, AR glasses 104, and/or HIPD 106 include a digital assistant to help user 108 in providing a user input (e.g., completing a sequence of operations, suggesting different operations or commands, providing reminders, confirming a command, etc.). In some embodiments, user 108 can provide a user input via one or more facial gestures and/or facial expressions. For example, cameras of wrist-wearable device 102, AR glasses 104, and/or HIPD 106 can track eyes of user 108 for navigating a user interface.

Wrist-wearable device 102, AR glasses 104, and/or HIPD 106 can operate alone or in conjunction to allow user 108 to interact with the AR environment. In some embodiments, HIPD 106 is configured to operate as a central hub or control center for the wrist-wearable device 102, AR glasses 104, and/or another communicatively coupled device. For example, user 108 can provide an input to interact with the AR environment at any of wrist-wearable device 102, AR glasses 104, and/or HIPD 106, and HIPD 106 can identify one or more back-end and front-end tasks to cause the performance of the requested interaction and distribute instructions to cause the performance of the one or more back-end and front-end tasks at wrist-wearable device 102, AR glasses 104, and/or HIPD 106. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). As described below in reference to FIG. 1, HIPD 106 can perform the back-end tasks and provide wrist-wearable device 102 and/or AR glasses 104 operational data corresponding to the performed back-end tasks such that wrist-wearable device 102 and/or AR glasses 104 can perform the front-end tasks. In this way, HIPD 106, which has more computational resources and greater thermal headroom than wrist-wearable device 102 and/or AR glasses 104, performs computationally intensive tasks and reduces the computer resource utilization and/or power usage of wrist-wearable device 102 and/or AR glasses 104.

In the example shown by first AR system 100, HIPD 106 identifies one or more back-end tasks and front-end tasks associated with a user request to initiate an AR video call with one or more other users (represented by avatar 110 and the digital representation of contact 112) and distributes instructions to cause the performance of the one or more back-end tasks and front-end tasks. In particular, HIPD 106 performs back-end tasks for processing and/or rendering image data (and other data) associated with the AR video call and provides operational data associated with the performed back-end tasks to AR glasses 104 such that the AR glasses 104 perform front-end tasks for presenting the AR video call (e.g., presenting avatar 110 and digital representation of contact 112).

In some embodiments, HIPD 106 can operate as a focal or anchor point for causing the presentation of information. This allows user 108 to be generally aware of where information is presented. For example, as shown in first AR system 100, avatar 110 and the digital representation of contact 112 are presented above HIPD 106. In particular, HIPD 106 and AR glasses 104 operate in conjunction to determine a location for presenting avatar 110 and the digital representation of contact 112. In some embodiments, information can be presented a predetermined distance from HIPD 106 (e.g., within 5 meters). For example, as shown in first AR system 100, virtual object 114 is presented on the desk some distance from HIPD 106. Similar to the above example, HIPD 106 and AR glasses 104 can operate in conjunction to determine a location for presenting virtual object 114. Alternatively, in some embodiments, presentation of information is not bound by HIPD 106. More specifically, avatar 110, digital representation of contact 112, and virtual object 114 do not have to be presented within a predetermined distance of HIPD 106.

User inputs provided at wrist-wearable device 102, AR glasses 104, and/or HIPD 106 are coordinated such that the user can use any device to initiate, continue, and/or complete an operation. For example, user 108 can provide a user input to AR glasses 104 to cause AR glasses 104 to present virtual object 114 and, while virtual object 114 is presented by AR glasses 104, user 108 can provide one or more hand gestures via wrist-wearable device 102 to interact and/or manipulate virtual object 114.

FIG. 2 shows a user 208 wearing a wrist-wearable device 202 and AR glasses 204, and holding an HIPD 206. In second AR system 200, the wrist-wearable device 202, AR glasses 204, and/or HIPD 206 are used to receive and/or provide one or more messages to a contact of user 208. In particular, wrist-wearable device 202, AR glasses 204, and/or HIPD 206 detect and coordinate one or more user inputs to initiate a messaging application and prepare a response to a received message via the messaging application.

In some embodiments, user 208 initiates, via a user input, an application on wrist-wearable device 202, AR glasses 204, and/or HIPD 206 that causes the application to initiate on at least one device. For example, in second AR system 200, user 208 performs a hand gesture associated with a command for initiating a messaging application (represented by messaging user interface 216), wrist-wearable device 202 detects the hand gesture and, based on a determination that user 208 is wearing AR glasses 204, causes AR glasses 204 to present a messaging user interface 216 of the messaging application. AR glasses 204 can present messaging user interface 216 to user 208 via its display (e.g., as shown by a field of view 218 of user 208). In some embodiments, the application is initiated and executed on the device (e.g., wrist-wearable device 202, AR glasses 204, and/or HIPD 206) that detects the user input to initiate the application, and the device provides another device operational data to cause the presentation of the messaging application. For example, wrist-wearable device 202 can detect the user input to initiate a messaging application, initiate and run the messaging application, and provide operational data to AR glasses 204 and/or HIPD 206 to cause presentation of the messaging application. Alternatively, the application can be initiated and executed at a device other than the device that detected the user input. For example, wrist-wearable device 202 can detect the hand gesture associated with initiating the messaging application and cause HIPD 206 to run the messaging application and coordinate the presentation of the messaging application.

Further, user 208 can provide a user input provided at wrist-wearable device 202, AR glasses 204, and/or HIPD 206 to continue and/or complete an operation initiated at another device. For example, after initiating the messaging application via wrist-wearable device 202 and while AR glasses 204 present messaging user interface 216, user 208 can provide an input at HIPD 206 to prepare a response (e.g., shown by the swipe gesture performed on HIPD 206). Gestures performed by user 208 on HIPD 206 can be provided and/or displayed on another device. For example, a swipe gestured performed on HIPD 206 is displayed on a virtual keyboard of messaging user interface 216 displayed by AR glasses 204.

In some embodiments, wrist-wearable device 202, AR glasses 204, HIPD 206, and/or any other communicatively coupled device can present one or more notifications to user 208. The notification can be an indication of a new message, an incoming call, an application update, a status update, etc. User 208 can select the notification via wrist-wearable device 202, AR glasses 204, and/or HIPD 206 and can cause presentation of an application or operation associated with the notification on at least one device. For example, user 208 can receive a notification that a message was received at wrist-wearable device 202, AR glasses 204, HIPD 206, and/or any other communicatively coupled device and can then provide a user input at wrist-wearable device 202, AR glasses 204, and/or HIPD 206 to review the notification, and the device detecting the user input can cause an application associated with the notification to be initiated and/or presented at wrist-wearable device 202, AR glasses 204, and/or HIPD 206.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 204 can present to user 208 game application data, and HIPD 206 can be used as a controller to provide inputs to the game. Similarly, user 208 can use wrist-wearable device 202 to initiate a camera of AR glasses 204, and user 308 can use wrist-wearable device 202, AR glasses 204, and/or HIPD 206 to manipulate the image capture (e.g., zoom in or out, apply filters, etc.) and capture image data.

Users may interact with the devices disclosed herein in a variety of ways. For example, as shown in FIGS. 3A and 3B, a user 308 may interact with an AR system 300 by donning a VR headset 350 while holding HIPD 306 and wearing wrist-wearable device 302. In this example, AR system 300 may enable a user to interact with a game 310 by swiping their arm. One or more of VR headset 350, HIPD 306, and wrist-wearable device 302 may detect this gesture and, in response, may display a sword strike in game 310. Similarly, in FIGS. 4A and 4B, a user 408 may interact with an AR system 400 by donning a VR headset 420 while wearing haptic device 460 and wrist-wearable device 430. In this example, AR system 400 may enable a user to interact with a game 410 by swiping their arm. One or more of VR headset 420, haptic device 460, and wrist-wearable device 430 may detect this gesture and, in response, may display a spell being cast in game 310.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiography (ECG or EKG) sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configure to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 702.15.4, Wi-Fi, ZigBee, 6LoWPAN, Thread, Z-Wave, Bluetooth Smart, ISA 100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 5 and 6 illustrate an example wrist-wearable device 500 and an example computer system 600, in accordance with some embodiments. Wrist-wearable device 500 is an instance of wearable device 102 described in FIG. 1 herein, such that the wearable device 102 should be understood to have the features of the wrist-wearable device 500 and vice versa. FIG. 6 illustrates components of the wrist-wearable device 500, which can be used individually or in combination, including combinations that include other electronic devices and/or electronic components.

FIG. 5 shows a wearable band 510 and a watch body 520 (or capsule) being coupled, as discussed below, to form wrist-wearable device 500. Wrist-wearable device 500 can perform various functions and/or operations associated with navigating through user interfaces and selectively opening applications as well as the functions and/or operations described above with reference to FIGS. 1, 2, 3A, 3B, 4A, and 4B.

As will be described in more detail below, operations executed by wrist-wearable device 500 can include (i) presenting content to a user (e.g., displaying visual content via a display 505), (ii) detecting (e.g., sensing) user input (e.g., sensing a touch on peripheral button 523 and/or at a touch screen of the display 505, a hand gesture detected by sensors (e.g., biopotential sensors)), (iii) sensing biometric data (e.g., neuromuscular signals, heart rate, temperature, sleep, etc.) via one or more sensors 513, messaging (e.g., text, speech, video, etc.); image capture via one or more imaging devices or cameras 525, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 520, independently in wearable band 510, and/or via an electronic communication between watch body 520 and wearable band 510. In some embodiments, functions can be executed on wrist-wearable device 500 while an AR environment is being presented (e.g., via one of AR systems 100 to 400). The wearable devices described herein can also be used with other types of AR environments.

Wearable band 510 can be configured to be worn by a user such that an inner surface of a wearable structure 511 of wearable band 510 is in contact with the user's skin. In this example, when worn by a user, sensors 513 may contact the user's skin. In some examples, one or more of sensors 513 can sense biometric data such as a user's heart rate, a saturated oxygen level, temperature, sweat level, neuromuscular signals, or a combination thereof. One or more of sensors 513 can also sense data about a user's environment including a user's motion, altitude, location, orientation, gait, acceleration, position, or a combination thereof. In some embodiment, one or more of sensors 513 can be configured to track a position and/or motion of wearable band 510. One or more of sensors 513 can include any of the sensors defined above and/or discussed below with respect to FIG. 5.

One or more of sensors 513 can be distributed on an inside and/or an outside surface of wearable band 510. In some embodiments, one or more of sensors 513 are uniformly spaced along wearable band 510. Alternatively, in some embodiments, one or more of sensors 513 are positioned at distinct points along wearable band 510. As shown in FIG. 5, one or more of sensors 513 can be the same or distinct. For example, in some embodiments, one or more of sensors 513 can be shaped as a pill (e.g., sensor 513a), an oval, a circle a square, an oblong (e.g., sensor 513c) and/or any other shape that maintains contact with the user's skin (e.g., such that neuromuscular signal and/or other biometric data can be accurately measured at the user's skin). In some embodiments, one or more sensors of 513 are aligned to form pairs of sensors (e.g., for sensing neuromuscular signals based on differential sensing within each respective sensor). For example, sensor 513b may be aligned with an adjacent sensor to form sensor pair 514a and sensor 513d may be aligned with an adjacent sensor to form sensor pair 514b. In some embodiments, wearable band 510 does not have a sensor pair. Alternatively, in some embodiments, wearable band 510 has a predetermined number of sensor pairs (one pair of sensors, three pairs of sensors, four pairs of sensors, six pairs of sensors, sixteen pairs of sensors, etc.).

Wearable band 510 can include any suitable number of sensors 513. In some embodiments, the number and arrangement of sensors 513 depends on the particular application for which wearable band 510 is used. For instance, wearable band 510 can be configured as an armband, wristband, or chest-band that include a plurality of sensors 513 with different number of sensors 513, a variety of types of individual sensors with the plurality of sensors 513, and different arrangements for each use case, such as medical use cases as compared to gaming or general day-to-day use cases.

In accordance with some embodiments, wearable band 510 further includes an electrical ground electrode and a shielding electrode. The electrical ground and shielding electrodes, like the sensors 513, can be distributed on the inside surface of the wearable band 510 such that they contact a portion of the user's skin. For example, the electrical ground and shielding electrodes can be at an inside surface of a coupling mechanism 516 or an inside surface of a wearable structure 511. The electrical ground and shielding electrodes can be formed and/or use the same components as sensors 513. In some embodiments, wearable band 510 includes more than one electrical ground electrode and more than one shielding electrode.

Sensors 513 can be formed as part of wearable structure 511 of wearable band 510. In some embodiments, sensors 513 are flush or substantially flush with wearable structure 511 such that they do not extend beyond the surface of wearable structure 511. While flush with wearable structure 511, sensors 513 are still configured to contact the user's skin (e.g., via a skin-contacting surface). Alternatively, in some embodiments, sensors 513 extend beyond wearable structure 511 a predetermined distance (e.g., 0.1-2 millimeters (mm)) to make contact and depress into the user's skin. In some embodiment, sensors 513 are coupled to an actuator (not shown) configured to adjust an extension height (e.g., a distance from the surface of wearable structure 511) of sensors 513 such that sensors 513 make contact and depress into the user's skin. In some embodiments, the actuators adjust the extension height between 0.01 mm-1.2 mm. This may allow a the user to customize the positioning of sensors 513 to improve the overall comfort of the wearable band 510 when worn while still allowing sensors 513 to contact the user's skin. In some embodiments, sensors 513 are indistinguishable from wearable structure 511 when worn by the user.

Wearable structure 511 can be formed of an elastic material, elastomers, etc., configured to be stretched and fitted to be worn by the user. In some embodiments, wearable structure 511 is a textile or woven fabric. As described above, sensors 513 can be formed as part of a wearable structure 511. For example, sensors 513 can be molded into the wearable structure 511, be integrated into a woven fabric (e.g., sensors 513 can be sewn into the fabric and mimic the pliability of fabric and can and/or be constructed from a series woven strands of fabric).

Wearable structure 511 can include flexible electronic connectors that interconnect sensors 513, the electronic circuitry, and/or other electronic components (described below in reference to FIG. 6) that are enclosed in wearable band 510. In some embodiments, the flexible electronic connectors are configured to interconnect sensors 513, the electronic circuitry, and/or other electronic components of wearable band 510 with respective sensors and/or other electronic components of another electronic device (e.g., watch body 520). The flexible electronic connectors are configured to move with wearable structure 511 such that the user adjustment to wearable structure 511 (e.g., resizing, pulling, folding, etc.) does not stress or strain the electrical coupling of components of wearable band 510.

As described above, wearable band 510 is configured to be worn by a user. In particular, wearable band 510 can be shaped or otherwise manipulated to be worn by a user. For example, wearable band 510 can be shaped to have a substantially circular shape such that it can be configured to be worn on the user's lower arm or wrist. Alternatively, wearable band 510 can be shaped to be worn on another body part of the user, such as the user's upper arm (e.g., around a bicep), forearm, chest, legs, etc. Wearable band 510 can include a retaining mechanism 512 (e.g., a buckle, a hook and loop fastener, etc.) for securing wearable band 510 to the user's wrist or other body part. While wearable band 510 is worn by the user, sensors 513 sense data (referred to as sensor data) from the user's skin. In some examples, sensors 513 of wearable band 510 obtain (e.g., sense and record) neuromuscular signals.

The sensed data (e.g., sensed neuromuscular signals) can be used to detect and/or determine the user's intention to perform certain motor actions. In some examples, sensors 513 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 505 of wrist-wearable device 500 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 513 can be used to provide a user with an enhanced interaction with a physical object (e.g., devices communicatively coupled with wearable band 510) and/or a virtual object in an artificial-reality application generated by an artificial-reality system (e.g., user interface objects presented on the display 505, or another computing device (e.g., a smartphone)).

In some embodiments, wearable band 510 includes one or more haptic devices 646 (e.g., a vibratory haptic actuator) that are configured to provide haptic feedback (e.g., a cutaneous and/or kinesthetic sensation, etc.) to the user's skin. Sensors 513 and/or haptic devices 646 (shown in FIG. 6) can be configured to operate in conjunction with multiple applications including, without limitation, health monitoring, social media, games, and artificial reality (e.g., the applications associated with artificial reality).

Wearable band 510 can also include coupling mechanism 516 for detachably coupling a capsule (e.g., a computing unit) or watch body 520 (via a coupling surface of the watch body 520) to wearable band 510. For example, a cradle or a shape of coupling mechanism 516 can correspond to shape of watch body 520 of wrist-wearable device 500. In particular, coupling mechanism 516 can be configured to receive a coupling surface proximate to the bottom side of watch body 520 (e.g., a side opposite to a front side of watch body 520 where display 505 is located), such that a user can push watch body 520 downward into coupling mechanism 516 to attach watch body 520 to coupling mechanism 516. In some embodiments, coupling mechanism 516 can be configured to receive a top side of the watch body 520 (e.g., a side proximate to the front side of watch body 520 where display 505 is located) that is pushed upward into the cradle, as opposed to being pushed downward into coupling mechanism 516. In some embodiments, coupling mechanism 516 is an integrated component of wearable band 510 such that wearable band 510 and coupling mechanism 516 are a single unitary structure. In some embodiments, coupling mechanism 516 is a type of frame or shell that allows watch body 520 coupling surface to be retained within or on wearable band 510 coupling mechanism 516 (e.g., a cradle, a tracker band, a support base, a clasp, etc.).

Coupling mechanism 516 can allow for watch body 520 to be detachably coupled to the wearable band 510 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 520 to wearable band 510 and to decouple the watch body 520 from the wearable band 510. For example, a user can twist, slide, turn, push, pull, or rotate watch body 520 relative to wearable band 510, or a combination thereof, to attach watch body 520 to wearable band 510 and to detach watch body 520 from wearable band 510. Alternatively, as discussed below, in some embodiments, the watch body 520 can be decoupled from the wearable band 510 by actuation of a release mechanism 529.

Wearable band 510 can be coupled with watch body 520 to increase the functionality of wearable band 510 (e.g., converting wearable band 510 into wrist-wearable device 500, adding an additional computing unit and/or battery to increase computational resources and/or a battery life of wearable band 510, adding additional sensors to improve sensed data, etc.). As described above, wearable band 510 and coupling mechanism 516 are configured to operate independently (e.g., execute functions independently) from watch body 520. For example, coupling mechanism 516 can include one or more sensors 513 that contact a user's skin when wearable band 510 is worn by the user, with or without watch body 520 and can provide sensor data for determining control commands.

A user can detach watch body 520 from wearable band 510 to reduce the encumbrance of wrist-wearable device 500 to the user. For embodiments in which watch body 520 is removable, watch body 520 can be referred to as a removable structure, such that in these embodiments wrist-wearable device 500 includes a wearable portion (e.g., wearable band 510) and a removable structure (e.g., watch body 520).

Turning to watch body 520, in some examples watch body 520 can have a substantially rectangular or circular shape. Watch body 520 is configured to be worn by the user on their wrist or on another body part. More specifically, watch body 520 is sized to be easily carried by the user, attached on a portion of the user's clothing, and/or coupled to wearable band 510 (forming the wrist-wearable device 500). As described above, watch body 520 can have a shape corresponding to coupling mechanism 516 of wearable band 510. In some embodiments, watch body 520 includes a single release mechanism 529 or multiple release mechanisms (e.g., two release mechanisms 529 positioned on opposing sides of watch body 520, such as spring-loaded buttons) for decoupling watch body 520 from wearable band 510. Release mechanism 529 can include, without limitation, a button, a knob, a plunger, a handle, a lever, a fastener, a clasp, a dial, a latch, or a combination thereof.

A user can actuate release mechanism 529 by pushing, turning, lifting, depressing, shifting, or performing other actions on release mechanism 529. Actuation of release mechanism 529 can release (e.g., decouple) watch body 520 from coupling mechanism 516 of wearable band 510, allowing the user to use watch body 520 independently from wearable band 510 and vice versa. For example, decoupling watch body 520 from wearable band 510 can allow a user to capture images using rear-facing camera 525b. Although release mechanism 529 is shown positioned at a corner of watch body 520, release mechanism 529 can be positioned anywhere on watch body 520 that is convenient for the user to actuate. In addition, in some embodiments, wearable band 510 can also include a respective release mechanism for decoupling watch body 520 from coupling mechanism 516. In some embodiments, release mechanism 529 is optional and watch body 520 can be decoupled from coupling mechanism 516 as described above (e.g., via twisting, rotating, etc.).

Watch body 520 can include one or more peripheral buttons 523 and 527 for performing various operations at watch body 520. For example, peripheral buttons 523 and 527 can be used to turn on or wake (e.g., transition from a sleep state to an active state) display 505, unlock watch body 520, increase or decrease a volume, increase or decrease a brightness, interact with one or more applications, interact with one or more user interfaces, etc. Additionally or alternatively, in some embodiments, display 505 operates as a touch screen and allows the user to provide one or more inputs for interacting with watch body 520.

In some embodiments, watch body 520 includes one or more sensors 521. Sensors 521 of watch body 520 can be the same or distinct from sensors 513 of wearable band 510. Sensors 521 of watch body 520 can be distributed on an inside and/or an outside surface of watch body 520. In some embodiments, sensors 521 are configured to contact a user's skin when watch body 520 is worn by the user. For example, sensors 521 can be placed on the bottom side of watch body 520 and coupling mechanism 516 can be a cradle with an opening that allows the bottom side of watch body 520 to directly contact the user's skin. Alternatively, in some embodiments, watch body 520 does not include sensors that are configured to contact the user's skin (e.g., including sensors internal and/or external to the watch body 520 that are configured to sense data of watch body 520 and the surrounding environment). In some embodiments, sensors 521 are configured to track a position and/or motion of watch body 520.

Watch body 520 and wearable band 510 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 520 and wearable band 510 can share data sensed by sensors 513 and 521, as well as application and device specific information (e.g., active and/or available applications, output devices (e.g., displays, speakers, etc.), input devices (e.g., touch screens, microphones, imaging sensors, etc.).

In some embodiments, watch body 520 can include, without limitation, a front-facing camera 525a and/or a rear-facing camera 525b, sensors 521 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 663), a touch sensor, a sweat sensor, etc.). In some embodiments, watch body 520 can include one or more haptic devices 676 (e.g., a vibratory haptic actuator) that is configured to provide haptic feedback (e.g., a cutaneous and/or kinesthetic sensation, etc.) to the user. Sensors 621 and/or haptic device 676 can also be configured to operate in conjunction with multiple applications including, without limitation, health monitoring applications, social media applications, game applications, and artificial reality applications (e.g., the applications associated with artificial reality).

As described above, watch body 520 and wearable band 510, when coupled, can form wrist-wearable device 500. When coupled, watch body 520 and wearable band 510 may operate as a single device to execute functions (operations, detections, communications, etc.) described herein. In some embodiments, each device may be provided with particular instructions for performing the one or more operations of wrist-wearable device 500. For example, in accordance with a determination that watch body 520 does not include neuromuscular signal sensors, wearable band 510 can include alternative instructions for performing associated instructions (e.g., providing sensed neuromuscular signal data to watch body 520 via a different electronic device). Operations of wrist-wearable device 500 can be performed by watch body 520 alone or in conjunction with wearable band 510 (e.g., via respective processors and/or hardware components) and vice versa. In some embodiments, operations of wrist-wearable device 500, watch body 520, and/or wearable band 510 can be performed in conjunction with one or more processors and/or hardware components.

As described below with reference to the block diagram of FIG. 6, wearable band 510 and/or watch body 520 can each include independent resources required to independently execute functions. For example, wearable band 510 and/or watch body 520 can each include a power source (e.g., a battery), a memory, data storage, a processor (e.g., a central processing unit (CPU)), communications, a light source, and/or input/output devices.

FIG. 6 shows block diagrams of a computing system 630 corresponding to wearable band 510 and a computing system 660 corresponding to watch body 520 according to some embodiments. Computing system 600 of wrist-wearable device 500 may include a combination of components of wearable band computing system 630 and watch body computing system 660, in accordance with some embodiments.

Watch body 520 and/or wearable band 510 can include one or more components shown in watch body computing system 660. In some embodiments, a single integrated circuit may include all or a substantial portion of the components of watch body computing system 660 included in a single integrated circuit. Alternatively, in some embodiments, components of the watch body computing system 660 may be included in a plurality of integrated circuits that are communicatively coupled. In some embodiments, watch body computing system 660 may be configured to couple (e.g., via a wired or wireless connection) with wearable band computing system 630, which may allow the computing systems to share components, distribute tasks, and/or perform other operations described herein (individually or as a single device).

Watch body computing system 660 can include one or more processors 679, a controller 677, a peripherals interface 661, a power system 695, and memory (e.g., a memory 680).

Power system 695 can include a charger input 696, a power-management integrated circuit (PMIC) 697, and a battery 698. In some embodiments, a watch body 520 and a wearable band 510 can have respective batteries (e.g., battery 698 and 659) and can share power with each other. Watch body 520 and wearable band 510 can receive a charge using a variety of techniques. In some embodiments, watch body 520 and wearable band 510 can use a wired charging assembly (e.g., power cords) to receive the charge. Alternatively, or in addition, watch body 520 and/or wearable band 510 can be configured for wireless charging. For example, a portable charging device can be designed to mate with a portion of watch body 520 and/or wearable band 510 and wirelessly deliver usable power to battery 698 of watch body 520 and/or battery 659 of wearable band 510. Watch body 520 and wearable band 510 can have independent power systems (e.g., power system 695 and 656, respectively) to enable each to operate independently. Watch body 520 and wearable band 510 can also share power (e.g., one can charge the other) via respective PMICs (e.g., PMICs 697 and 658) and charger inputs (e.g., 657 and 696) that can share power over power and ground conductors and/or over wireless charging antennas.

In some embodiments, peripherals interface 661 can include one or more sensors 621. Sensors 621 can include one or more coupling sensors 662 for detecting when watch body 520 is coupled with another electronic device (e.g., a wearable band 510). Sensors 621 can include one or more imaging sensors 663 (e.g., one or more of cameras 625, and/or separate imaging sensors 663 (e.g., thermal-imaging sensors)). In some embodiments, sensors 621 can include one or more SpO2 sensors 664. In some embodiments, sensors 621 can include one or more biopotential-signal sensors (e.g., EMG sensors 665, which may be disposed on an interior, user-facing portion of watch body 520 and/or wearable band 510). In some embodiments, sensors 621 may include one or more capacitive sensors 666. In some embodiments, sensors 621 may include one or more heart rate sensors 667. In some embodiments, sensors 621 may include one or more IMU sensors 668. In some embodiments, one or more IMU sensors 668 can be configured to detect movement of a user's hand or other location where watch body 520 is placed or held.

In some embodiments, one or more of sensors 621 may provide an example human-machine interface. For example, a set of neuromuscular sensors, such as EMG sensors 665, may be arranged circumferentially around wearable band 510 with an interior surface of EMG sensors 665 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 510 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 679. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 665 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 661 includes a near-field communication (NFC) component 669, a global-position system (GPS) component 670, a long-term evolution (LTE) component 671, and/or a Wi-Fi and/or Bluetooth communication component 672. In some embodiments, peripherals interface 661 includes one or more buttons 673 (e.g., peripheral buttons 523 and 527 in FIG. 5), which, when selected by a user, cause operation to be performed at watch body 520. In some embodiments, the peripherals interface 661 includes one or more indicators, such as a light emitting diode (LED), to provide a user with visual indicators (e.g., message received, low battery, active microphone and/or camera, etc.).

Watch body 520 can include at least one display 505 for displaying visual representations of information or data to a user, including user-interface elements and/or three-dimensional virtual objects. The display can also include a touch screen for inputting user inputs, such as touch gestures, swipe gestures, and the like. Watch body 520 can include at least one speaker 674 and at least one microphone 675 for providing audio signals to the user and receiving audio input from the user. The user can provide user inputs through microphone 675 and can also receive audio output from speaker 674 as part of a haptic event provided by haptic controller 678. Watch body 520 can include at least one camera 625, including a front camera 625a and a rear camera 625b. Cameras 625 can include ultra-wide-angle cameras, wide angle cameras, fish-eye cameras, spherical cameras, telephoto cameras, depth-sensing cameras, or other types of cameras.

Watch body computing system 660 can include one or more haptic controllers 678 and associated componentry (e.g., haptic devices 676) for providing haptic events at watch body 520 (e.g., a vibrating sensation or audio output in response to an event at the watch body 520). Haptic controllers 678 can communicate with one or more haptic devices 676, such as electroacoustic devices, including a speaker of the one or more speakers 674 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 678 can provide haptic events to that are capable of being sensed by a user of watch body 520. In some embodiments, one or more haptic controllers 678 can receive input signals from an application of applications 682.

In some embodiments, wearable band computing system 630 and/or watch body computing system 660 can include memory 680, which can be controlled by one or more memory controllers of controllers 677. In some embodiments, software components stored in memory 680 include one or more applications 682 configured to perform operations at the watch body 520. In some embodiments, one or more applications 682 may include games, word processors, messaging applications, calling applications, web browsers, social media applications, media streaming applications, financial applications, calendars, clocks, etc. In some embodiments, software components stored in memory 680 include one or more communication interface modules 683 as defined above. In some embodiments, software components stored in memory 680 include one or more graphics modules 684 for rendering, encoding, and/or decoding audio and/or visual data and one or more data management modules 685 for collecting, organizing, and/or providing access to data 687 stored in memory 680. In some embodiments, one or more of applications 682 and/or one or more modules can work in conjunction with one another to perform various tasks at the watch body 520.

In some embodiments, software components stored in memory 680 can include one or more operating systems 681 (e.g., a Linux-based operating system, an Android operating system, etc.). Memory 680 can also include data 687. Data 687 can include profile data 688A, sensor data 689A, media content data 690, and application data 691.

It should be appreciated that watch body computing system 660 is an example of a computing system within watch body 520, and that watch body 520 can have more or fewer components than shown in watch body computing system 660, can combine two or more components, and/or can have a different configuration and/or arrangement of the components. The various components shown in watch body computing system 660 are implemented in hardware, software, firmware, or a combination thereof, including one or more signal processing and/or application-specific integrated circuits.

Turning to the wearable band computing system 630, one or more components that can be included in wearable band 510 are shown. Wearable band computing system 630 can include more or fewer components than shown in watch body computing system 660, can combine two or more components, and/or can have a different configuration and/or arrangement of some or all of the components. In some embodiments, all, or a substantial portion of the components of wearable band computing system 630 are included in a single integrated circuit. Alternatively, in some embodiments, components of wearable band computing system 630 are included in a plurality of integrated circuits that are communicatively coupled. As described above, in some embodiments, wearable band computing system 630 is configured to couple (e.g., via a wired or wireless connection) with watch body computing system 660, which allows the computing systems to share components, distribute tasks, and/or perform other operations described herein (individually or as a single device).

Wearable band computing system 630, similar to watch body computing system 660, can include one or more processors 649, one or more controllers 647 (including one or more haptics controllers 648), a peripherals interface 631 that can includes one or more sensors 613 and other peripheral devices, a power source (e.g., a power system 656), and memory (e.g., a memory 650) that includes an operating system (e.g., an operating system 651), data (e.g., data 654 including profile data 688B, sensor data 689B, etc.), and one or more modules (e.g., a communications interface module 652, a data management module 653, etc.).

One or more of sensors 613 can be analogous to sensors 621 of watch body computing system 660. For example, sensors 613 can include one or more coupling sensors 632, one or more SpO2 sensors 634, one or more EMG sensors 635, one or more capacitive sensors 636, one or more heart rate sensors 637, and one or more IMU sensors 638.

Peripherals interface 631 can also include other components analogous to those included in peripherals interface 661 of watch body computing system 660, including an NFC component 639, a GPS component 640, an LTE component 641, a Wi-Fi and/or Bluetooth communication component 642, and/or one or more haptic devices 646 as described above in reference to peripherals interface 661. In some embodiments, peripherals interface 631 includes one or more buttons 643, a display 633, a speaker 644, a microphone 645, and a camera 655. In some embodiments, peripherals interface 631 includes one or more indicators, such as an LED.

It should be appreciated that wearable band computing system 630 is an example of a computing system within wearable band 510, and that wearable band 510 can have more or fewer components than shown in wearable band computing system 630, combine two or more components, and/or have a different configuration and/or arrangement of the components. The various components shown in wearable band computing system 630 can be implemented in one or more of a combination of hardware, software, or firmware, including one or more signal processing and/or application-specific integrated circuits.

Wrist-wearable device 500 with respect to FIG. 5 is an example of wearable band 510 and watch body 520 coupled together, so wrist-wearable device 500 will be understood to include the components shown and described for wearable band computing system 630 and watch body computing system 660. In some embodiments, wrist-wearable device 500 has a split architecture (e.g., a split mechanical architecture, a split electrical architecture, etc.) between watch body 520 and wearable band 510. In other words, all of the components shown in wearable band computing system 630 and watch body computing system 660 can be housed or otherwise disposed in a combined wrist-wearable device 500 or within individual components of watch body 520, wearable band 510, and/or portions thereof (e.g., a coupling mechanism 516 of wearable band 510).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 500 can be used in conjunction with a head-wearable device (e.g., AR glasses 700 and VR system 810) and/or an HIPD described below, and wrist-wearable device 500 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR glasses 700 and VR headset 810.

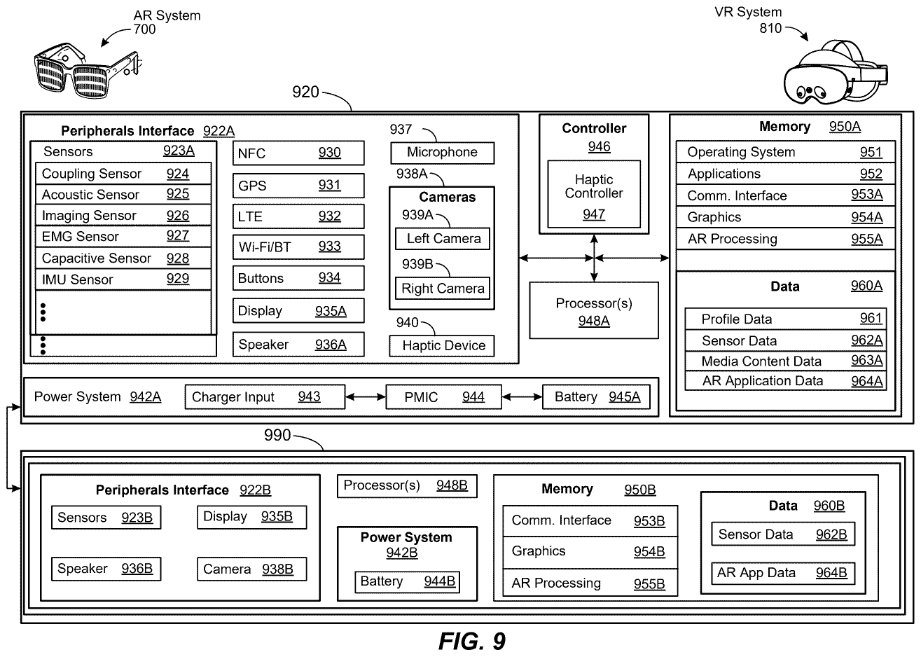

FIGS. 7, 8A, 8B, and 9 show example artificial-reality systems, which can be used as or in connection with wrist-wearable device 500. In some embodiments, AR system 700 includes an eyewear device 702, as shown in FIG. 7. In some embodiments, VR system 810 includes a head-mounted display (HMD) 812, as shown in FIGS. 8A and 8B. In some embodiments, AR system 700 and VR system 810 can include one or more analogous components (e.g., components for presenting interactive artificial-reality environments, such as processors, memory, and/or presentation devices, including one or more displays and/or one or more waveguides), some of which are described in more detail with respect to FIG. 9. As described herein, a head-wearable device can include components of eyewear device 702 and/or head-mounted display 812. Some embodiments of head-wearable devices do not include any displays, including any of the displays described with respect to AR system 700 and/or VR system 810. While the example artificial-reality systems are respectively described herein as AR system 700 and VR system 810, either or both of the example AR systems described herein can be configured to present fully-immersive virtual-reality scenes presented in substantially all of a user's field of view or subtler augmented-reality scenes that are presented within a portion, less than all, of the user's field of view.

FIG. 7 show an example visual depiction of AR system 700, including an eyewear device 702 (which may also be described herein as augmented-reality glasses, and/or smart glasses). AR system 700 can include additional electronic components that are not shown in FIG. 7, such as a wearable accessory device and/or an intermediary processing device, in electronic communication or otherwise configured to be used in conjunction with the eyewear device 702. In some embodiments, the wearable accessory device and/or the intermediary processing device may be configured to couple with eyewear device 702 via a coupling mechanism in electronic communication with a coupling sensor 924 (FIG. 9), where coupling sensor 924 can detect when an electronic device becomes physically or electronically coupled with eyewear device 702. In some embodiments, eyewear device 702 can be configured to couple to a housing 990 (FIG. 9), which may include one or more additional coupling mechanisms configured to couple with additional accessory devices. The components shown in FIG. 7 can be implemented in hardware, software, firmware, or a combination thereof, including one or more signal-processing components and/or application-specific integrated circuits (ASICs).

Eyewear device 702 includes mechanical glasses components, including a frame 704 configured to hold one or more lenses (e.g., one or both lenses 706-1 and 706-2). One of ordinary skill in the art will appreciate that eyewear device 702 can include additional mechanical components, such as hinges configured to allow portions of frame 704 of eyewear device 702 to be folded and unfolded, a bridge configured to span the gap between lenses 706-1 and 706-2 and rest on the user's nose, nose pads configured to rest on the bridge of the nose and provide support for eyewear device 702, earpieces configured to rest on the user's ears and provide additional support for eyewear device 702, temple arms configured to extend from the hinges to the earpieces of eyewear device 702, and the like. One of ordinary skill in the art will further appreciate that some examples of AR system 700 can include none of the mechanical components described herein. For example, smart contact lenses configured to present artificial reality to users may not include any components of eyewear device 702.

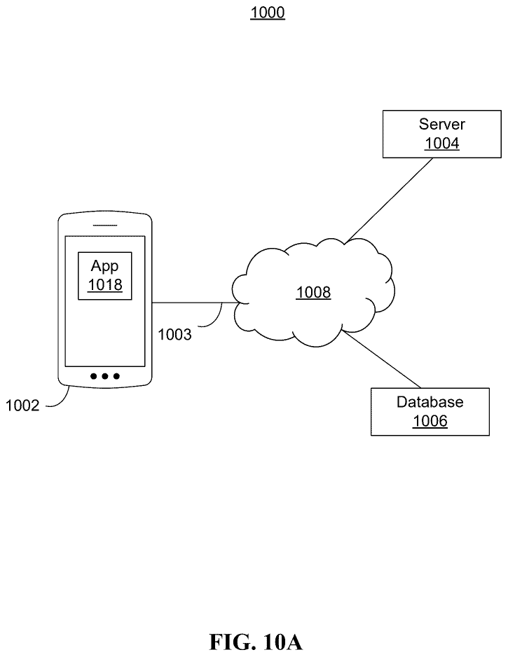

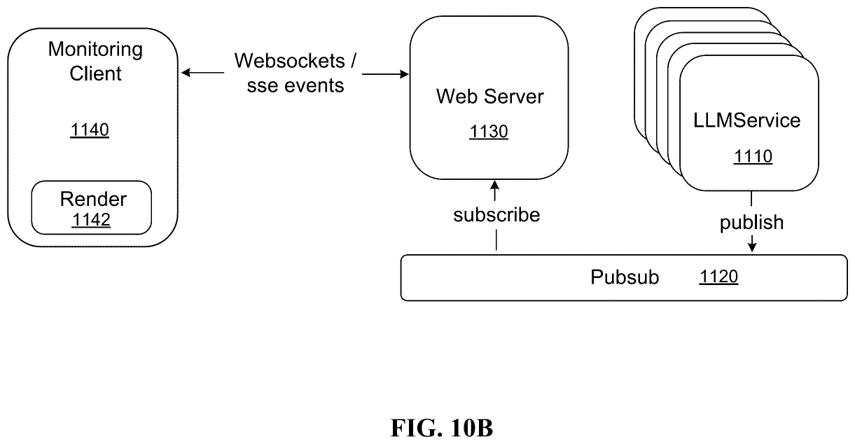

Eyewear device 702 includes electronic components, many of which will be described in more detail below with respect to FIG. 10. Some example electronic components are illustrated in FIG. 7, including acoustic sensors 725-1, 725-2, 725-3, 725-4, 725-5, and 725-6, which can be distributed along a substantial portion of the frame 704 of eyewear device 702. Eyewear device 702 also includes a left camera 739A and a right camera 739B, which are located on different sides of the frame 704. Eyewear device 702 also includes a processor 748 (or any other suitable type or form of integrated circuit) that is embedded into a portion of the frame 704.

FIGS. 8A and 8B show a VR system 810 that includes a head-mounted display (HMD) 812 (e.g., also referred to herein as an artificial-reality headset, a head-wearable device, a VR headset, etc.), in accordance with some embodiments. As noted, some artificial-reality systems (e.g., AR system 700) may, instead of blending an artificial reality with actual reality, substantially replace one or more of a user's visual and/or other sensory perceptions of the real world with a virtual experience (e.g., AR systems 300 and 400).

HMD 812 includes a front body 814 and a frame 816 (e.g., a strap or band) shaped to fit around a user's head. In some embodiments, front body 814 and/or frame 816 include one or more electronic elements for facilitating presentation of and/or interactions with an AR and/or VR system (e.g., displays, IMUs, tracking emitter or detectors). In some embodiments, HMD 812 includes output audio transducers (e.g., an audio transducer 818), as shown in FIG. 8B. In some embodiments, one or more components, such as the output audio transducer(s) 818 and frame 816, can be configured to attach and detach (e.g., are detachably attachable) to HMD 812 (e.g., a portion or all of frame 816, and/or audio transducer 818), as shown in FIG. 8B. In some embodiments, coupling a detachable component to HMD 812 causes the detachable component to come into electronic communication with HMD 812.

FIGS. 8A and 8B also show that VR system 810 includes one or more cameras, such as left camera 839A and right camera 839B, which can be analogous to left and right cameras 739A and 739B on frame 704 of eyewear device 702. In some embodiments, VR system 810 includes one or more additional cameras (e.g., cameras 839C and 839D), which can be configured to augment image data obtained by left and right cameras 839A and 839B by providing more information. For example, camera 839C can be used to supply color information that is not discerned by cameras 839A and 839B. In some embodiments, one or more of cameras 839A to 839D can include an optional IR cut filter configured to remove IR light from being received at the respective camera sensors.

FIG. 9 illustrates a computing system 920 and an optional housing 990, each of which show components that can be included in AR system 700 and/or VR system 810. In some embodiments, more or fewer components can be included in optional housing 990 depending on practical restraints of the respective AR system being described.

In some embodiments, computing system 920 can include one or more peripherals interfaces 922A and/or optional housing 990 can include one or more peripherals interfaces 922B. Each of computing system 920 and optional housing 990 can also include one or more power systems 942A and 942B, one or more controllers 946 (including one or more haptic controllers 947), one or more processors 948A and 948B (as defined above, including any of the examples provided), and memory 950A and 950B, which can all be in electronic communication with each other. For example, the one or more processors 948A and 948B can be configured to execute instructions stored in memory 950A and 950B, which can cause a controller of one or more of controllers 946 to cause operations to be performed at one or more peripheral devices connected to peripherals interface 922A and/or 922B. In some embodiments, each operation described can be powered by electrical power provided by power system 942A and/or 942B.

In some embodiments, peripherals interface 922A can include one or more devices configured to be part of computing system 920, some of which have been defined above and/or described with respect to the wrist-wearable devices shown in FIGS. 5 and 6. For example, peripherals interface 922A can include one or more sensors 923A. Some example sensors 923A include one or more coupling sensors 924, one or more acoustic sensors 925, one or more imaging sensors 926, one or more EMG sensors 927, one or more capacitive sensors 928, one or more IMU sensors 929, and/or any other types of sensors explained above or described with respect to any other embodiments discussed herein.

In some embodiments, peripherals interfaces 922A and 922B can include one or more additional peripheral devices, including one or more NFC devices 930, one or more GPS devices 931, one or more LTE devices 932, one or more Wi-Fi and/or Bluetooth devices 933, one or more buttons 934 (e.g., including buttons that are slidable or otherwise adjustable), one or more displays 935A and 935B, one or more speakers 936A and 936B, one or more microphones 937, one or more cameras 938A and 938B (e.g., including the left camera 939A and/or a right camera 939B), one or more haptic devices 940, and/or any other types of peripheral devices defined above or described with respect to any other embodiments discussed herein.

AR systems can include a variety of types of visual feedback mechanisms (e.g., presentation devices). For example, display devices in AR system 700 and/or VR system 810 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 935A and 935B can be coupled to each of the lenses 706-1 and 706-2 of AR system 700. Displays 935A and 935B may be coupled to each of lenses 706-1 and 706-2, which can act together or independently to present an image or series of images to a user. In some embodiments, AR system 700 includes a single display 935A or 935B (e.g., a near-eye display) or more than two displays 935A and 935B. In some embodiments, a first set of one or more displays 935A and 935B can be used to present an augmented-reality environment, and a second set of one or more display devices 935A and 935B can be used to present a virtual-reality environment. In some embodiments, one or more waveguides are used in conjunction with presenting artificial-reality content to the user of AR system 700 (e.g., as a means of delivering light from one or more displays 935A and 935B to the user's eyes). In some embodiments, one or more waveguides are fully or partially integrated into the eyewear device 702. Additionally, or alternatively to display screens, some artificial-reality systems include one or more projection systems. For example, display devices in AR system 700 and/or VR system 810 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 935A and 935B.

Computing system 920 and/or optional housing 990 of AR system 700 or VR system 810 can include some or all of the components of a power system 942A and 942B. Power systems 942A and 942B can include one or more charger inputs 943, one or more PMICs 944, and/or one or more batteries 945A and 944B.

Memory 950A and 950B may include instructions and data, some or all of which may be stored as non-transitory computer-readable storage media within the memories 950A and 950B. For example, memory 950A and 950B can include one or more operating systems 951, one or more applications 952, one or more communication interface applications 953A and 953B, one or more graphics applications 954A and 954B, one or more AR processing applications 955A and 955B, and/or any other types of data defined above or described with respect to any other embodiments discussed herein.

Memory 950A and 950B also include data 960A and 960B, which can be used in conjunction with one or more of the applications discussed above. Data 960A and 960B can include profile data 961, sensor data 962A and 962B, media content data 963A, AR application data 964A and 964B, and/or any other types of data defined above or described with respect to any other embodiments discussed herein.

In some embodiments, controller 946 of eyewear device 702 may process information generated by sensors 923A and/or 923B on eyewear device 702 and/or another electronic device within AR system 700. For example, controller 946 can process information from acoustic sensors 725-1 and 725-2. For each detected sound, controller 946 can perform a direction of arrival (DOA) estimation to estimate a direction from which the detected sound arrived at eyewear device 702 of R system 700. As one or more of acoustic sensors 925 (e.g., the acoustic sensors 725-1, 725-2) detects sounds, controller 946 can populate an audio data set with the information (e.g., represented in FIG. 10 as sensor data 962A and 962B).

In some embodiments, a physical electronic connector can convey information between eyewear device 702 and another electronic device and/or between one or more processors 748, 948A, 948B of AR system 700 or VR system 810 and controller 946. The information can be in the form of optical data, electrical data, wireless data, or any other transmittable data form. Moving the processing of information generated by eyewear device 702 to an intermediary processing device can reduce weight and heat in the eyewear device, making it more comfortable and safer for a user. In some embodiments, an optional wearable accessory device (e.g., an electronic neckband) is coupled to eyewear device 702 via one or more connectors. The connectors can be wired or wireless connectors and can include electrical and/or non-electrical (e.g., structural) components. In some embodiments, eyewear device 702 and the wearable accessory device can operate independently without any wired or wireless connection between them.

In some situations, pairing external devices, such as an intermediary processing device (e.g., HIPD 106, 206, 306) with eyewear device 702 (e.g., as part of AR system 700) enables eyewear device 702 to achieve a similar form factor of a pair of glasses while still providing sufficient battery and computation power for expanded capabilities. Some, or all, of the battery power, computational resources, and/or additional features of AR system 700 can be provided by a paired device or shared between a paired device and eyewear device 702, thus reducing the weight, heat profile, and form factor of eyewear device 702 overall while allowing eyewear device 702 to retain its desired functionality. For example, the wearable accessory device can allow components that would otherwise be included on eyewear device 702 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 702 standing alone. Because weight carried in the wearable accessory device can be less invasive to a user than weight carried in the eyewear device 702, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 700 and/or VR system 810 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 8A and 8B show VR system 810 having cameras 839A to 839D, which can be used to provide depth information for creating a voxel field and a two-dimensional mesh to provide object information to the user to avoid collisions.

In some embodiments, AR system 700 and/or VR system 810 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 700 and/or VR system 810, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

### B. Artificial Intelligence Continuous Activity Tracking (AI CAT) Scanner For Real Time Rendering Of Language Models Thoughts

### Technological Field

The present disclosure relates to computing systems and, more particularly, to systems and methods for visualizing operations of artificial intelligence systems.

### Background

Artificial intelligence (AI) systems, particularly those employing large language models, perform numerous concurrent tasks when processing user requests. Conventional systems provide limited visibility into these operations, typically displaying only basic status indicators such as loading spinners or progress bars.

### Summary

The disclosed subject matter provides methods, apparatuses, and systems for visualizing artificial intelligence operations in real-time. In various embodiments, a computing device monitors multiple tasks associated with AI operations, publishes status events for these tasks, and renders a graphical visualization displaying the real-time status of the tasks. This visualization can take the form of a radar graph with different regions representing different types of tasks and different colors representing different task states.

The system can aggregate task status data over predetermined time intervals and update the visualization accordingly. It can also adapt the visualization based on the display capabilities of different user devices. The visualization can include numerical indicators showing quantities of tasks in various states for different task types.

In some embodiments, the system filters status events based on user identifiers, allowing personalized monitoring for different users or applications. The system can also detect user interactions with the visualization and display more detailed task information in response.

The disclosed techniques can be applied to various types of AI processing tasks, including natural language processing, computer vision, voice processing, and structured/unstructured data processing. By providing a clear, real-time view of AI system activities, these techniques can improve user experience, system monitoring, and AI operation management.

This disclosure presents systems and methods for real-time visualization of artificial intelligence (AI) operations. A computing device monitors AI tasks, publishes status events, and renders a graphical visualization of task statuses. The system aggregates data over set intervals, updates the visualization accordingly, and adapts it to various display capabilities. It can filter events by user identifiers and show numerical task quantity indicators. These techniques apply to diverse AI tasks like natural language processing, computer vision, and data processing.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### Detailed Description

Some embodiments of the present invention will now be described more fully hereinafter with reference to the accompanying drawings, in which some, but not all embodiments of the invention are shown. Various embodiments of the invention may be embodied in many different forms and should not be construed as limited to the embodiments set forth herein. Like reference numerals refer to like elements throughout.

Some embodiments of the present invention will now be described more fully hereinafter with reference to the accompanying drawings, in which some, but not all embodiments of the invention are shown. Various embodiments of the invention may be embodied in many different forms and should not be construed as limited to the embodiments set forth herein. Like reference numerals refer to like elements throughout.

It is to be understood that the methods and systems described herein are not limited to specific methods, specific components, or to particular implementations. It is also to be understood that the terminology used herein is for the purpose of describing particular embodiments only and is not intended to be limiting.

Artificial intelligence (AI) and large language model (LLM) systems have become increasingly complex, often involving numerous distributed components and subtasks to process even relatively simple requests. For example, responding to a user query might involve database lookups, internet searches, natural language processing, and integration of multiple data sources. However, the internal workings of these AI systems are typically opaque to end users, who are presented with little to no information about the underlying processes occurring as their requests are handled.

Conventional AI interfaces often provide minimal feedback, such as a simple loading indicator or animated ellipsis, which fails to convey meaningful information about the AI's activities or progress. This lack of transparency can lead to user frustration, especially when responses take longer than expected. Additionally, in enterprise or development contexts, the inability to monitor AI system activities in detail impedes effective debugging, optimization, or resource management.

Some approaches may attempt to provide insight into AI processes, such as displaying intermediate steps in chain-of-thought reasoning. However, these approaches may be limited to specific types of AI tasks and do not provide a comprehensive, real-time view of the diverse operations occurring across distributed AI components. Furthermore, they typically lack the flexibility to adapt to different deployment scenarios or user needs.

There is a need for improved systems and methods that can provide near real-time, detailed visualizations of AI operations across distributed components, enhancing transparency, user experience, or system manageability.

The disclosed subject matter introduces the AI Continuous Activity Tracker (AI CAT) Scanner which may help visualize near real-time distributed AI task states. The AI CAT Scanner may help address a transparency gap by integrating a publish-subscribe (pub-sub) architecture, a visualization component, or adaptive rendering mechanisms.

In an example, there may be continuous tracking of task states across distributed processing nodes, aggregation of this data, and rendering it graphically, such as in a radar graph format. This example architecture may provide real-time feedback on task types (e.g., text generation, data retrieval) and statuses (e.g., requested, in-progress, completed) which may empower a user to understand and interact more effectively with AI systems.

FIG. 10A illustrates an example system 1000 for AI CAT scanning. System 1000 may include user device 1002, server 1004, or server 1006 which may be communicatively connected with each other via a network 1008. User device 1002 may be a smartphone, tablet, laptop computer, or other device which may interface with an AI service. User device 1002 may include a display.

Server 1004 may receive messages (e.g., AI-related requests) from user device 1002 and process such messages to generate an associated AI output, such as text, video, or an image. Server 1006 may be used to monitor operations (e.g., AI-related tasks or events) associated with received messages, as further disclosed herein. Server 1006 may be used to access, store, or generate visualizations of tasks.

User device 1002 may include AI-related application 118 that is configured to receive AI-related commands and display output associated with such commands. Application 1018 may be a standalone app or integrated into a social media platform app.

FIG. 10B illustrates exemplary functional components associated with system 1000 for visualizing AI operations. System 1000 may include multiple language model services 1110, publish-subscribe (pub-sub) bus 1120, web server 1130, or one or more monitoring clients 1140.

Language model services 1110 may be located on server 1004 and may represent various AI components that process tasks such as natural language understanding, text generation, image analysis, voice processing, and data retrieval. These language model services 1110 may publish task status events to the pub/sub bus 120 as they process requests.

Pub-sub bus 1120 may act as a central message broker, allowing services to publish events and other components to subscribe to relevant event streams. Pub-sub bus 1120 may facilitate distributed communication by transmitting (e.g., broadcasting) task status events. In an example, pub-sub bus 1120 may act as a central hub for publishing task states from processing nodes and distributing them to visualization clients. This decoupled architecture may enable scalability and flexibility in system 100.

Web server 1130 (e.g., server 1006) may subscribe to task status events from pub-sub bus 1120 and may maintain websocket connections with monitoring client 1140. Web server 1130 may forward relevant events to the clients, potentially filtering or aggregating data based on client-specific parameters.

Monitoring client 1140 may include renderer component 1142. Render component 1142 may generate visualizations of AI task statuses based on the received events. These visualizations may be displayed on various devices, such as user device 1002 (e.g., desktop computers, mobile phones, or specialized monitoring dashboards).

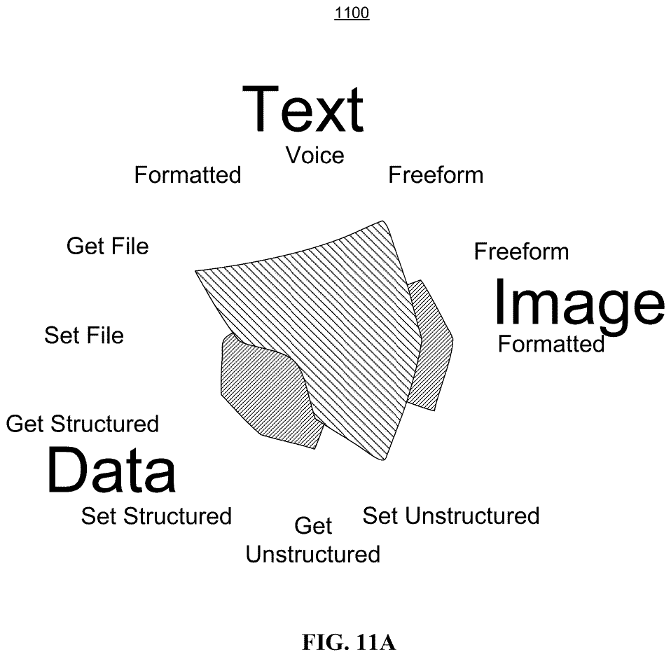

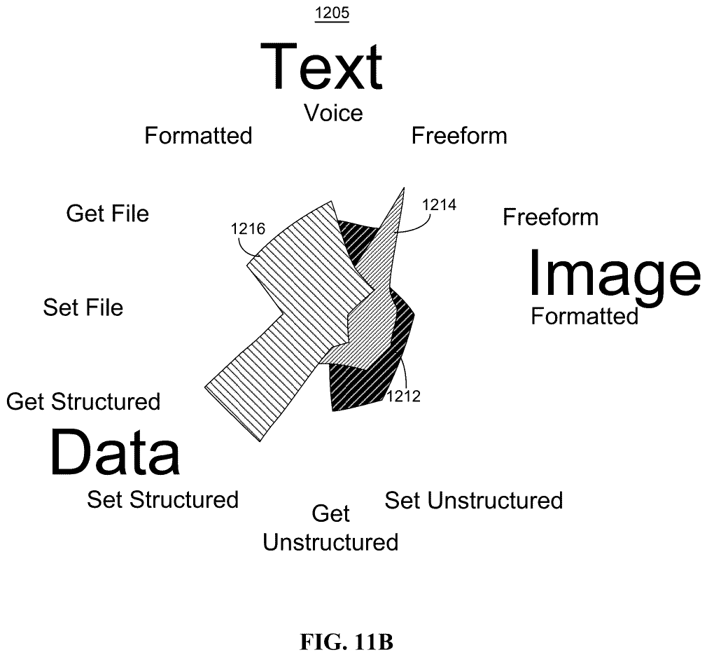

FIG. 11A and FIG. 11B illustrate example visualizations that may be rendered (e.g., displayed) on user device 1002. As shown, FIG. 11A illustrates an example first instance of a visualization of AI operations and FIG. 11B illustrates an example second instance of a visualization of AI operations. System 1000 may employ multiple techniques to provide near real-time visualizations of AI operations, which may offer insight into the processes occurring within AI systems. These techniques may work in concert to create a dynamic, informative, or user-friendly interface for monitoring AI activities. Activities, tasks, operations, events, or the like may be used visualized. It is contemplated that the visualization system may represent tasks and their states, using events to update this representation in near real-time, which may allow the display of the current status and progress of various AI tasks within the broader context of AI operations. Operations may be the highest-level units, potentially including multiple tasks. Tasks may be specific units of work that make up operations and have defined types and states. Activities may be the ongoing processes within tasks. Events may be the specific status updates about tasks that drive the visualization.

FIG. 11A and FIG. 11B illustrate an example visualization system associated with a radar graph. This graphical representation may serve as an intuitive way to display the multifaceted nature of AI operations. Radar graph 1100 and radar graph 1205 are divided into different regions, which may represent a distinct type of AI task. For instance, radar graph 1205 might include sectors dedicated to text processing (both formatted and freeform), image analysis (again, in formatted and freeform variants), voice processing, structured and unstructured data operations, or file handling. This segmentation may allow users to quickly identify which types of AI tasks are currently active or prominent, which may be associated with one or more session.

To further enhance the information conveyed by radar graph 1205, system 1000 may employ a color-coding, hashing, or other scheme to represent the state of tasks within each category. In an example scenario associated with color, purple scheme 1212 may indicate requested tasks that have been initiated but not yet started processing. Blue scheme 1214 may indicate in-progress tasks, showing which operations are currently being executed by the AI system. Green scheme 1216 may indicate completed tasks, providing a visual cue for work that has been finished. This scheme may enable users to rapidly assess the current activity levels and progress across different AI components at a glance.

Complementing the visual representation of radar graph 1205, numerical indicators may be overlayed that display the precise quantity of tasks in each state for each task type. These indicators may provide a count of how many tasks are requested, in progress, or completed for each AI operation category. By combining the intuitive visual representation of radar graph 1205 with specific numerical data, users may gain both a quick overview and detailed insights into the AI system's current state.

To manage the potentially overwhelming volume of updates in a high-frequency AI system, the visualization may employ time-based aggregation. Rather than updating the display with every individual task state change, which may lead to a chaotic and unreadable interface, system 1000 may aggregate task status data over defined time intervals (e.g., around one second). The visualization may then be updated at these regular intervals, showing the accumulated state changes. This approach may strike a balance between providing real-time information and maintaining a stable, comprehensible display.

Recognizing that there may be a variety of devices that may be used to monitor AI operations, system 1000 may incorporate adaptive rendering capabilities. The display capabilities of user device 1002 may be detected and the visualization may be adjusted accordingly. For example, when displayed on a small mobile screen, a simplified version of radar graph 1205 may be rendered with fewer details than a desktop computer attached to one or more displays. On a large desktop monitor or extended reality device, there may be a more detailed 3D visualization that takes advantage of the additional screen real estate to provide even more comprehensive information.

System 1000 may offer user-specific filtering to cater to different monitoring needs. By filtering task status events based on user identifiers or other criteria, system 1000 may provide personalized monitoring views. This feature may be particularly valuable in multi-user or multi-application environments, in which different users profiles or AI instances may need to focus on specific subsets of the overall AI operations. This feature may allow for tailored monitoring experiences that highlight the most relevant information for each user profile or application.

Together, these techniques may create a powerful and flexible system for visualizing AI operations in real-time. By combining intuitive graphical representations with precise numerical data, time-based aggregation, adaptive rendering, or personalized filtering, system 1000 may allow for monitoring and understanding complex AI processes as they unfold.

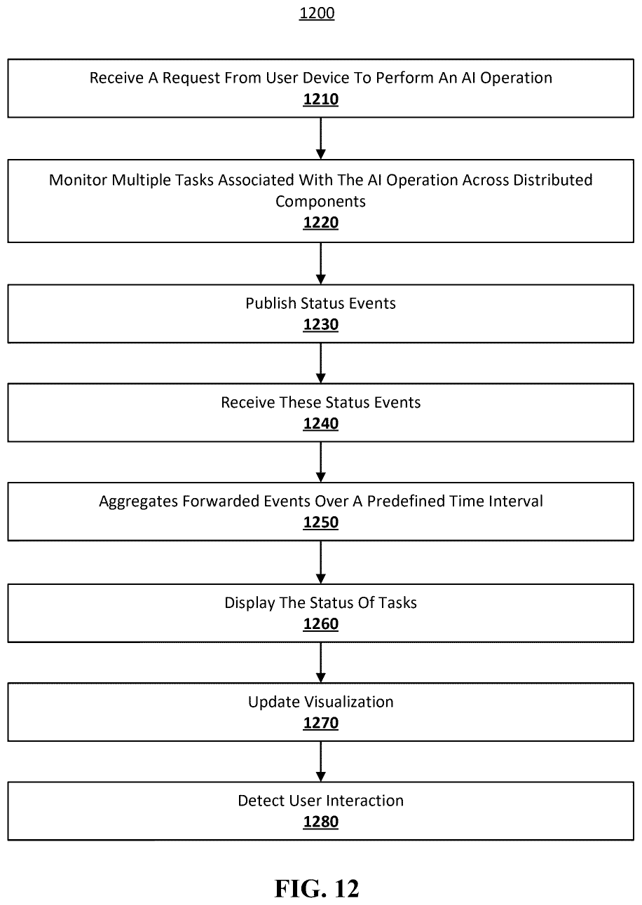

FIG. 12 illustrates an example method 1200 for AI CAT scanning as disclosed herein. At step 1210, system 1000 may receive a request from user device 1002 to perform an AI operation. This request may range from a simple text query to a complex data analysis task. Upon receiving the request, system 1000 (e.g., server 1004) may break down the operation into multiple smaller tasks that may be distributed across various AI components.

At step 1220, system 1000 may initiate and monitor multiple tasks associated with the AI operation across distributed components. These tasks might include natural language processing, data retrieval, image analysis, or other specialized AI functions. Each task may be assigned to an appropriate AI component, which may be running on different servers or in different geographic locations. System 1000 may keep track of the status of each task, which may ensure that components are working in concert to fulfill the request of step 1210.

At step 1230, as the tasks progress, the AI components publish status events to the publish-subscribe (pub/sub) bus. These events may include information about each task's current state, including whether it has been initiated, is in progress, or has been completed. The pub/sub bus may act as a central nervous system for the entire AI operation, which may allow components to communicate efficiently without needing to know about each other's existence or location.

At step 1240, web server 1130 for example, which is subscribed to relevant topics on the pub/sub bus, may receive these status events. Web server 1130 then processes and forwards them to the appropriate monitoring clients. This step 1240 may help ensure that only relevant information reaches each client, preventing information overload and maintaining system efficiency. Web server 1130 might apply filters based on user permissions, task types, or other criteria to determine which events should be sent to which clients.

At step 1250, upon receiving the forwarded events, the monitoring client aggregates them over a predefined time interval. This aggregation step 1250 may be significant for managing the potentially high volume of status updates generated by complex AI operations. By consolidating events over short time periods, system 1000 may provide a smooth, real-time visualization without overwhelming the user interface of user device 1002 or consuming excessive computational resources.

At step 1260, with the aggregated data in hand, a graphical visualization displaying the near real-time status of tasks may be rendered on user device 1002. This visualization may take the form of radar graph 1205, where different regions represent various types of AI tasks, and colors (or other schemes) may indicate the current state of each task type. Radar graph 1205 and the like schemes may provide an intuitive, at-a-glance overview of the entire AI operation, allowing users to quickly understand which types of tasks are most active and how the operation is progressing overall.

At step 1270, the visualization may be updated at regular intervals as new event data may be received. These updates may reflect the dynamic nature of AI operations, with task states constantly shifting as work is completed and new tasks are initiated. The regular updates may ensure that the most current information about the AI system's activities are displayed.

At step 1280, the system may detect user interaction with the visualization and displays more detailed information about specific tasks or components. This interactivity may allow users to drill down into particular areas of interest, gaining deeper insights into specific aspects of the AI operation. For example, a user might click on a region of the radar graph representing natural language processing tasks to see a breakdown of individual tasks within that category, including their current status, duration, and any relevant metadata.

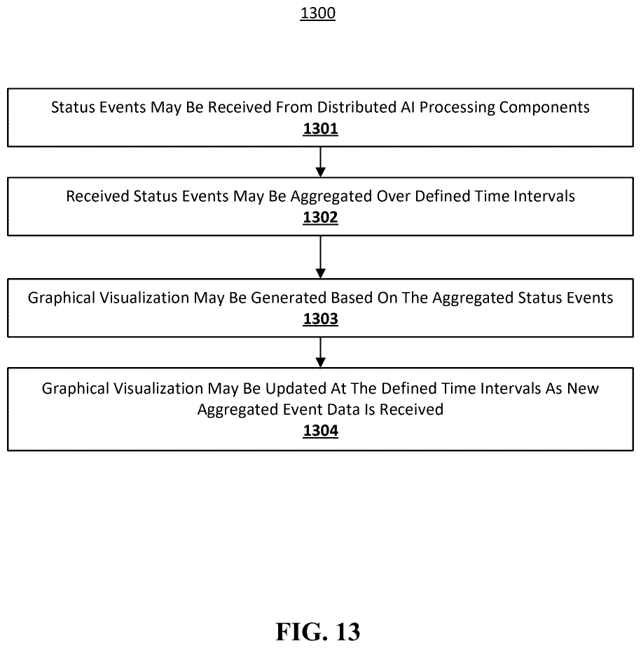

FIG. 13 illustrates an example method 1300 for visualizing artificial intelligence (AI) operations as disclosed herein. At step 1301, status events may be received from distributed AI processing components. These components may include various AI modules performing different types of processing tasks across a distributed system.

At step 1302, the received status events may be aggregated over defined time intervals. This aggregation may help manage the potentially high volume of status updates generated by complex AI operations. By consolidating events over short time periods, such as every second, system 1000 may provide a smooth visualization without overwhelming computational resources.

At step 1303, a graphical visualization may be generated based on the aggregated status events. This visualization may take various forms, such as radar graph 1205 in which different regions represent different types of AI tasks and colors (or other schemes) indicate the current state of each task type.

At step 1304, the graphical visualization may be updated at the defined time intervals as new aggregated event data is received. These regular updates may ensure that users have current information about the AI system's activities, reflecting the dynamic nature of AI operations with task states constantly shifting as work is completed and new tasks are initiated.

The disclosed methods of operation represent a significant advancement in the field of AI system monitoring and visualization. By providing a continuous, real-time view of AI system activities, it enhances transparency and user understanding in ways that were previously not possible. Users can now observe the complex interplay of various AI components as they work together to complete tasks, gaining valuable insights into system performance, resource utilization, or potential bottlenecks.

Moreover, this approach to visualization may adapt to the scale and complexity of modern AI systems. Whether the operation involves a handful of simple tasks or thousands of interconnected processes, the radar graph visualization may effectively summarize and present the relevant information. This scalability may make the disclosed subject matter suitable for a wide range of applications, from individual user queries to large-scale enterprise AI deployments.

The real-time nature of the visualization may enable more responsive and informed decision-making. System administrators can quickly identify and address issues as they arise, while end-users can better understand the progress of their requests, leading to improved user experience and increased trust in AI systems. This method of monitoring and visualizing AI operations represents a powerful tool for enhancing the transparency, efficiency, or user-friendliness of AI systems.

A method, system, or apparatus may provide for visualizing artificial intelligence (AI) operations. Methods, systems, or apparatus may provide for receiving a user request for an AI operation, monitoring tasks associated with the operation, publishing and receiving status events, and rendering a graphical visualization. The visualization may display the real-time status of tasks using a radar graph, with distinct regions for different task types and colors indicating various task states. These task states may include requested, in-progress, and completed states, represented by unique colors. Task types may encompass text, voice, structured data, unstructured data, file handling, or image processing tasks.

Further, a computing device may aggregate task status data over specified intervals and update the graphical visualization accordingly. It may adapt the visualization based on detected user device display capabilities or filter status events by user identifier. Graphical elements may also include numerical indicators showing quantities of tasks in respective states for each task type. Rendering the visualization ensures the display is responsive to user interactions and device-specific attributes.

Methods for visualizing AI operations may involve receiving status events from distributed processing components, aggregating these over time intervals, generating visualizations, and updating them periodically. Such visualizations may include radar graphs with task-type regions, color-coded states, and numerical task quantities. Interactivity allows users to access detailed task information. Distributed processing components could include natural language, computer vision, voice, or structured and unstructured data components.

A non-transitory computer-readable medium may store instructions enabling a processor to receive and filter task status events, aggregate them over time, and render a radar graph showing task types, states, and quantities. Similarly, a system may include language model services publishing task events to a subscribe-publish bus, a web server subscribed to this bus, and a monitoring client receiving and visualizing events via a websocket connection. The renderer in this system generates radar graphs with task states represented by unique colors. The web server may forward events filtered by user identifiers, while the monitoring client aggregates these events and updates the visualization at set intervals.

The system may also support methods for publishing task status events from language model services to a publish-subscribe bus, subscribing via a web server, and rendering visualizations at monitoring clients. Rendered graphs may highlight task types and states using color codes and update at defined intervals. A computer-readable storage medium might store instructions for establishing websocket connections, receiving task events, and rendering responsive visualizations. Such instructions could also ensure aggregation of events over intervals and periodic updates to the visualization. All combinations (including the removal or addition of steps) in this paragraph and the above paragraphs are contemplated in a manner that is consistent with the other portions of the detailed description.

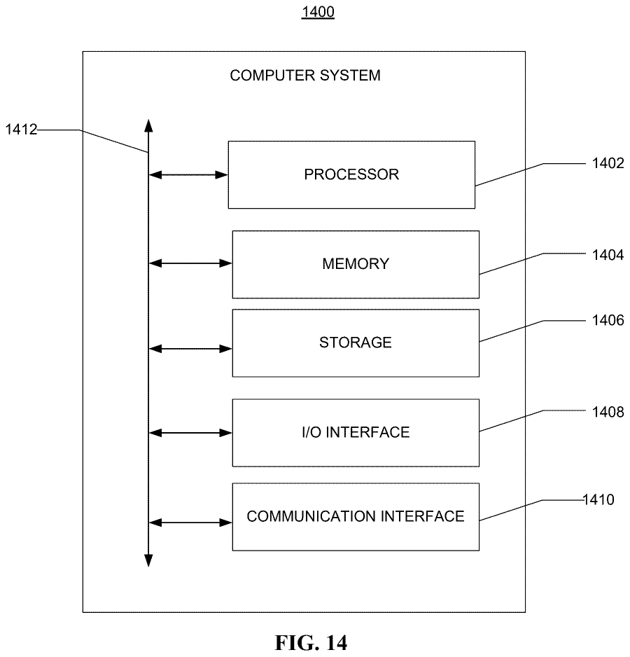

FIG. 14 illustrates an example computer system 1400. In examples, one or more computer systems 1400 perform one or more steps of one or more methods described or illustrated herein. In particular embodiments, one or more computer systems 1400 (e.g., user device 1002, server 1006, or server 1004) provide functionality described or illustrated herein. In examples, software running on one or more computer systems 1400 performs one or more steps of one or more methods described or illustrated herein or provides functionality described or illustrated herein. Examples include one or more portions of one or more computer systems 1400. Herein, reference to a computer system may encompass a computing device, and vice versa, where appropriate. Moreover, reference to a computer system may encompass one or more computer systems, where appropriate.

This disclosure contemplates any suitable number of computer systems 1400. This disclosure contemplates computer system 1400 taking any suitable physical form. As example and not by way of limitation, computer system 1400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1400 may include one or more computer systems 1400; be unitary or distributed; span multiple locations; span multiple machines; span multiple data centers; or reside in a cloud, which may include one or more cloud components in one or more networks. Where appropriate, one or more computer systems 1400 may perform without substantial spatial or temporal limitation one or more steps of one or more methods described or illustrated herein. As an example, and not by way of limitation, one or more computer systems 1400 may perform in real time or in batch mode one or more steps of one or more methods described or illustrated herein. One or more computer systems 1400 may perform at different times or at different locations one or more steps of one or more methods described or illustrated herein, where appropriate.

In examples, computer system 1400 includes a processor 1402, memory 1404, storage 1406, an input/output (I/O) interface 1408, a communication interface 1410, and a bus 1412 (e.g., communication bus 1003). Although this disclosure describes and illustrates a particular computer system having a particular number of particular components in a particular arrangement, this disclosure contemplates any suitable computer system having any suitable number of any suitable components in any suitable arrangement.

In examples, processor 1402 includes hardware for executing instructions, such as those making up a computer program. As an example, and not by way of limitation, to execute instructions, processor 1402 may retrieve (or fetch) the instructions from an internal register, an internal cache, memory 1404, or storage 1406; decode and execute them; and then write one or more results to an internal register, an internal cache, memory 1404, or storage 1406. In particular embodiments, processor 1402 may include one or more internal caches for data, instructions, or addresses. This disclosure contemplates processor 1402 including any suitable number of any suitable internal caches, where appropriate. As an example, and not by way of limitation, processor 1402 may include one or more instruction caches, one or more data caches, and one or more translation lookaside buffers (TLBs). Instructions in the instruction caches may be copies of instructions in memory 1404 or storage 1406, and the instruction caches may speed up retrieval of those instructions by processor 1402. Data in the data caches may be copies of data in memory 1404 or storage 1406 for instructions executing at processor 1402 to operate on; the results of previous instructions executed at processor 1402 for access by subsequent instructions executing at processor 1402 or for writing to memory 1404 or storage 1406; or other suitable data. The data caches may speed up read or write operations by processor 1402. The TLBs may speed up virtual-address translation for processor 1402. In particular embodiments, processor 1402 may include one or more internal registers for data, instructions, or addresses. This disclosure contemplates processor 1402 including any suitable number of any suitable internal registers, where appropriate. Where appropriate, processor 1402 may include one or more arithmetic logic units (ALUs); be a multi-core processor; or include one or more processors 1402. Although this disclosure describes and illustrates a particular processor, this disclosure contemplates any suitable processor.

In examples, memory 1404 includes main memory for storing instructions for processor 1402 to execute or data for processor 1402 to operate on. As an example, and not by way of limitation, computer system 1400 may load instructions from storage 1406 or another source (such as, for example, another computer system 1400) to memory 1404. Processor 1402 may then load the instructions from memory 1404 to an internal register or internal cache. To execute the instructions, processor 1402 may retrieve the instructions from the internal register or internal cache and decode them. During or after execution of the instructions, processor 1402 may write one or more results (which may be intermediate or final results) to the internal register or internal cache. Processor 1402 may then write one or more of those results to memory 1404. In particular embodiments, processor 71402 executes only instructions in one or more internal registers or internal caches or in memory 1404 (as opposed to storage 1406 or elsewhere) and operates only on data in one or more internal registers or internal caches or in memory 1404 (as opposed to storage 1406 or elsewhere). One or more memory buses (which may each include an address bus and a data bus) may couple processor 1402 to memory 1404. Bus 1412 may include one or more memory buses, as described below. In examples, one or more memory management units (MMUs) reside between processor 1402 and memory 1404 and facilitate accesses to memory 1404 requested by processor 1402. In particular embodiments, memory 1404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1404 may include one or more memories 1404, where appropriate. Although this disclosure describes and illustrates particular memory, this disclosure contemplates any suitable memory.

In examples, storage 1406 includes mass storage for data or instructions. As an example, and not by way of limitation, storage 1406 may include a hard disk drive (HDD), a floppy disk drive, flash memory, an optical disc, a magneto-optical disc, magnetic tape, or a Universal Serial Bus (USB) drive or a combination of two or more of these. Storage 1406 may include removable or non-removable (or fixed) media, where appropriate. Storage 1406 may be internal or external to computer system 1400, where appropriate. In examples, storage 1406 is non-volatile, solid-state memory. In particular embodiments, storage 1406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1406 taking any suitable physical form. Storage 1406 may include one or more storage control units facilitating communication between processor 1402 and storage 1406, where appropriate. Where appropriate, storage 1406 may include one or more storages 1406. Although this disclosure describes and illustrates particular storage, this disclosure contemplates any suitable storage.

In examples, I/O interface 1408 includes hardware, software, or both, providing one or more interfaces for communication between computer system 1400 and one or more I/O devices. Computer system 1400 may include one or more of these I/O devices, where appropriate. One or more of these I/O devices may enable communication between a person and computer system 1400. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1408 for them. Where appropriate, I/O interface 1408 may include one or more device or software drivers enabling processor 1402 to drive one or more of these I/O devices. I/O interface 708 may include one or more I/O interfaces 1408, where appropriate. Although this disclosure describes and illustrates a particular I/O interface, this disclosure contemplates any suitable I/O interface.

In examples, communication interface 1410 includes hardware, software, or both providing one or more interfaces for communication (such as, for example, packet-based communication) between computer system 1400 and one or more other computer systems 1400 or one or more networks. As an example, and not by way of limitation, communication interface 1410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1410 for it. As an example, and not by way of limitation, computer system 1400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1400 may include any suitable communication interface 1410 for any of these networks, where appropriate. Communication interface 1410 may include one or more communication interfaces 1410, where appropriate. Although this disclosure describes and illustrates a particular communication interface, this disclosure contemplates any suitable communication interface.

In particular embodiments, bus 1412 includes hardware, software, or both coupling components of computer system 1400 to each other. As an example and not by way of limitation, bus 1412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1412 may include one or more buses 1412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, computer readable medium or any suitable combination of two or more of these, where appropriate. A computer-readable non-transitory storage medium may be volatile, non-volatile, or a combination of volatile and non-volatile, where appropriate.

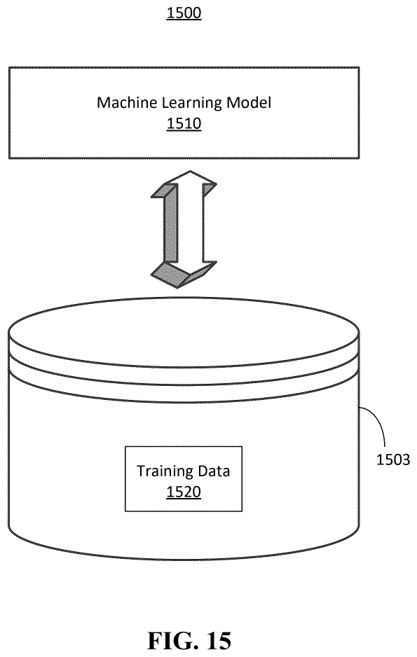

FIG. 15 illustrates a framework 1500 associated with machine learning (also referred herein as artificial intelligence (AI)). The framework 1500 may be hosted remotely. Alternatively, the framework 1500 may reside within the system 1000 shown in FIG. 10A and may be processed/implemented by a device. In some examples, the machine learning model 1510 (also referred to herein as artificial intelligence model 1510) may be implemented/executed by a network device (e.g., server 1004 or server 1006). In other examples, the machine learning model 1510 may be implemented/executed by other devices (e.g., user device 1002). The machine learning model 1510 may be operably coupled with the stored training data in a training database 1503 (e.g., data store). In some examples, the machine learning model 1510 may be associated with other operations. The machine learning model 1510 may be one or more machine learning models.

In another example, the training data 1520 may include attributes of thousands of objects. For example, the objects may be associated with tasks (e.g., operations) with regard to AI. Attributes may include but are not limited to the size, shape, orientation, position of the object(s), etc. The training data 1520 employed by the machine learning model 1510 may be fixed or updated periodically. Alternatively, the training data 1520 may be updated in real-time based upon the evaluations performed by the machine learning model 1510 in a non-training mode. This is illustrated by the double-sided arrow connecting the machine learning model 1510 and stored training data 1520.

The machine learning model 1510 may be designed to generate one or more visualizations (e.g., generate FIG. 11A or FIG. 11B) associated with one or more received inputs, based in part on utilizing determined contextual information. This information includes fields like a description, variables defined, data category associated with the variables and the output (e.g., graphical output), and responses to generated prompts. The machine learning model 1510 may be a large language model to generate representations (e.g., vector spaces), or embeddings, of one or more of the one or more inputs received. These machine learning model 1510 may be trained (e.g., pretrained and/or trained in real-time) on a vast amount of textual data (e.g., associated with the one or more inputs), previous responses to one or more prompts generated, previously generated visualizations, and/or data capture of a wide range of language patterns and semantic meanings. The machine learning model 1510 may understand and represent the context of words, terms, phrases and/or the like in a high-dimensional space, effectively capturing/determining the semantic similarities between different received inputs, including descriptions and responses to prompts, even when they are not exactly the same.

Example aspects of the present disclosure may deploy a machine learning model(s) (e.g., machine learning model 1510) that may be flexible, adaptive, automated, temporal, learns quickly and trainable. Manual operations or brute force device operations may be unnecessary for the examples of the present disclosure due to the learning framework aspects of the present disclosure that are implementable by the machine learning model 1510.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

While the disclosed systems have been described in connection with the various examples of the various figures, it is to be understood that other similar implementations may be used or modifications and additions may be made to the described examples of a robotic skin or AI robotics platform, among other things as disclosed herein. For example, one skilled in the art will recognize that robotic skin or AI robotics platform, among other things as disclosed herein in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—verifying authenticity of media content—as illustrated in the Figures, specific terminology is employed for the sake of clarity. The claimed subject matter, however, is not intended to be limited to the specific terminology so selected.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

This written description uses examples to enable any person skilled in the art to practice the claimed subject matter, including making and using any devices or systems and performing any incorporated methods. Other variations of the examples are contemplated herein. It is to be appreciated that certain features of the disclosed subject matter which are, for clarity, described herein in the context of separate embodiments, may also be provided in combination in a single embodiment. Conversely, various features of the disclosed subject matter that are, for brevity, described in the context of a single embodiment, may also be provided separately or in any sub-combination. Further, any reference to values stated in ranges includes each and every value within that range. Any documents cited herein are incorporated herein by reference in their entireties for any and all purposes.

The scope of this disclosure encompasses all changes, substitutions, variations, alterations, and modifications to the example embodiments described or illustrated herein that a person having ordinary skill in the art would comprehend. The scope of this disclosure is not limited to the examples described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

### C. Using a Model for Computer Code Review

### Technical Field

This application is directed to automated computer code review, and more particularly, to using a trained large language model for differential review of computer code and provide suggestions to the differential review.

### Background

When computer code changes, the differential, or diff, representing the code change is sent for review by a reviewer. The diff review process checks for various potential issues with the computer code. Currently, this diff review process is done manually. As a result, the diff review process may be performed subjectively based on the reviewer's experience and other factors.

### Brief Summary

The following application is directed to using a machine language model (e.g., large language model—MLM) for diff review of computer code. Based on the review, the MLM may provide suggestions to the computer code.

In an example, training data includes: obtaining a differential between a first version of the computer code and a second version of the computer code; performing, in accordance with one or more rules, a review of the differential; assigning, based on the review, a score to the differential; and in response to the score being below a threshold score, automatically generating, based on the review, one or more suggested updates to the computer code.

In another example, an apparatus includes one or more processors. The apparatus further candles at least one memory storing instructions, that when executed by the one or more processors, cause the one or more processors to: obtain a differential between a first version of the computer code and a second version of the computer code; perform, in accordance with one or more rules, a review of the differential; assign, based on the review, a score to the differential; and in response to the score being below a threshold score, automatically generate, based on the review, one or more suggested updates to the computer code.

In another example, a non-transitory computer-readable medium storing instructions that, when executed, cause: obtaining a differential between a first version of the computer code and a second version of the computer code; performing, in accordance with one or more rules, a review of the differential; assigning, based on the review, a score to the differential; and in response to the score being below a threshold score, automatically generating, based on the review, one or more suggested updates to the computer code.

A model (e.g., MLM) may perform automated diff review of code and provide suggestions to the diff review. Additionally, the model may evaluate the diff review and assign a score to the diff review. The model may determine whether to provide the suggestions to the diff review to the coder based on the score. For example, if the score is at or above a threshold score, then the model may forgo providing the suggestions. Conversely, if the score is below the threshold score, then the model may provide the suggestions.

### Detailed Description

The subject technology is directed to using a trained MLM-based model for reviewing computer code and providing suggestions (e.g., suggested updates) to the computer code. For example, MLM s described herein may review changes to the computer code (e.g., diff review) generated by a coder (e.g., human code drafter), and generate suggestions, based on the review, for enhancing the quality of the computer code. The MLM diff review may be provided to a code reviewer to assist in the diff review of the code. MLM s described herein may provide suggestion based on a variety of factors such as functionality and correctness, readability, maintainability and extensibility, edge handling cases, absence of bugs, performance, error handling, testability, and code duplication. The suggestions may be provided to the coder for possible changes to the computer code. When trained, the MLM may provide an objective review as compared to manual review. In some instances, an MLM may provide several suggestions, some of which may not be critical or may be unnecessary. In one or more implementations, MLMs described herein are trained to score the diff review of the computer code. For example, the quality of the code change may be scored and if the score is below a threshold score, then the MLM will provide the suggestion(s) to the computer code. Conversely, if the score is at or above the threshold score, then the MLM may forgo (e.g., may not provide) suggestion(s). Beneficially, using a score to limit suggestions may limit the overall review process and prevent coders from reviewing unnecessary suggestions.

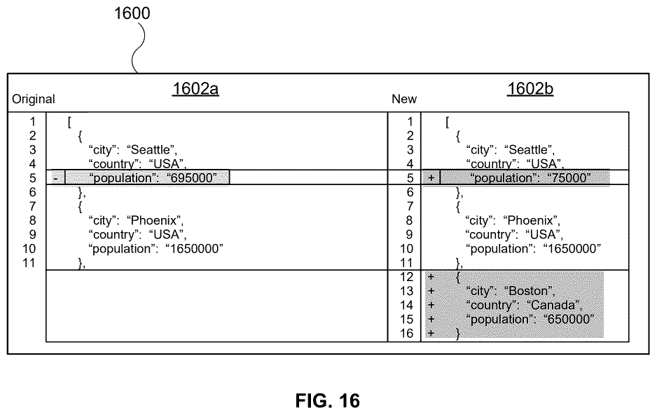

These and other embodiments are discussed below with reference to FIGS. 16, 17, 18, 19, 20, 21, and 22. However, those skilled in the art will readily appreciate that the detailed description given herein with respect to these Figures is for explanatory purposes only and should not be construed as limiting.

FIG. 16 illustrates an example of computer code, in accordance with aspects of the present disclosure. As shown on an electronic device 1600 (e.g., display of an electronic device), computer code 1602a may take the form of a first version (e.g., initial version) of computer code written by a coder. Further, computer code 1602b may take the form of a second version (e.g., subsequent version) of computer code written by the coder. The computer code 1602a may be presented from a file (e.g., text file) that includes originally drafted computer code, and the computer code 1602b is presented from a separate file that includes updated, or newly drafted, computer code. The highlighted portions of the computer code 1602a and the computer code 1602b represent the difference (e.g., in terms of text and/or characters) between the computer code 1602a and the computer code 1602b. Generally, a code reviewer is responsible for diff review, which includes reviewing the change(s) from the computer code 1602a (e.g., original) to the computer code 1602b (e.g., new). In one or more implementations, the diff review is manually performed.

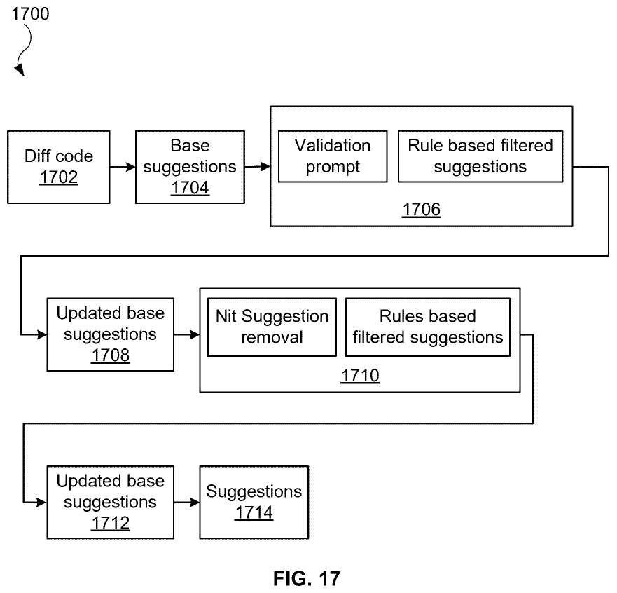

FIG. 17 illustrates a flowchart showing a process 1700 for generating suggestions for diff review, in accordance with aspects of the present disclosure. At operation 1702, diff code is received. The diff code may be provided to an MLM. The diff code may include computer code for various applications, thus allowing the MLM, when trained to have a better understanding of the applications. At operation 1704, the MLM generates and provides base suggestions for the diff code. In some instances, the base suggestions may be less critical, less useful, not pertaining to the code itself, likely to be ignored by the coder, or a combination thereof. At operation 1706, the base suggestions are passed through a validation prompt. The validation prompt generates a validation layer based on the base suggestions. Further, at operation 1706, a rules based filter for suggestions is generated for the MLM. The rules based filter may use the validation layer to generate additional rules and provide the filter to the MLM to filter less important suggestions such that these less important suggestions are not generated by the MLM.

At operation 1708, updated suggestions may be provided as a result of filtering less important suggestions. At operation 1710, the updated suggestions undergo a nit suggestion removal. The nit suggestion removal may remove, for example, comments in code review that does not impact the quality of the code. Further, at operation 1710, a rules based filter for suggestions is applied on the suggestions which looks for keywords and patterns to remove them for more actionable suggestions.

At operation 1712, updated suggestions may be provided as a result of multi layer filtering to extract the most impactful and relevant suggestions. The additional updated suggestions result in suggestions generated by the MLM that correspond more to actionable items to the code that would, for example, enhance code quality and provide some positive impact on the overall code. At operation 1714, the updated suggestions are provided to the user.

It should be noted that the MLM may be trained for different programming languages. In this regard, the MLM may be customizable to a particular language and use case on which the MLM was trained.

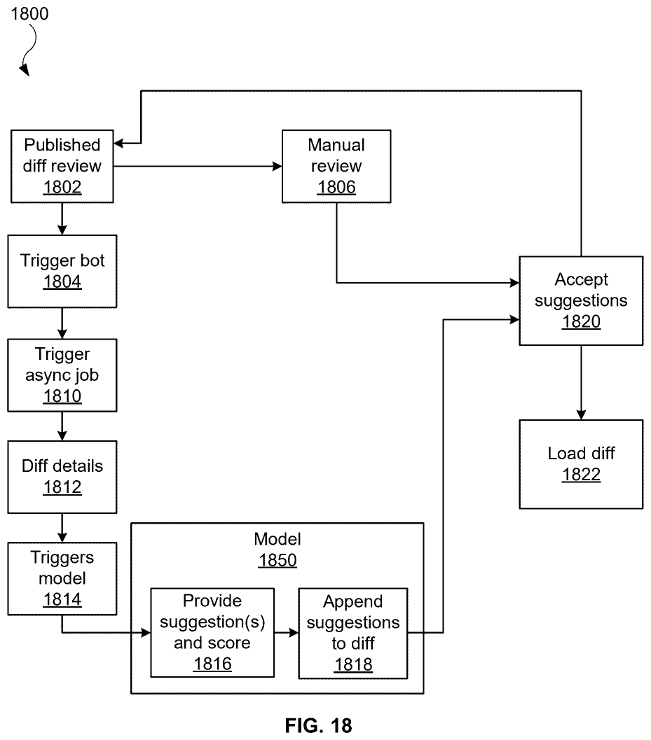

FIG. 18 illustrates a flowchart showing a process 1800 for managing diff review, in accordance with aspects of the present disclosure. At operation 1802, published diff review is provided. When a diff is published, a bot is triggered at operation 1804. The bot may be designed or programmed with rules to take action based on the rules for diffs matching a predefined criteria. In this regard, the bot may be trained to initiate automated diff review for a model (e.g., model 1850, including an MLM, shown below). Also, at operation 1806, the published diff review is sent to a reviewer for review of the diff code. The review may be done by a computing device or manual.

At operation 1810, the bot triggers an async job. The async job may include code for interactions between the model 1850 and the diff review. At operation 1812, the async job may request or instruct the model 1850 to fetch a portion (e.g., specific aspects) of the computer code, including portions of the code change from the diff review performed by the coder. The instructions for fetching the code may be based in part on the rules provided by the bot.

At operation 1814, the model (e.g., model 1850) is triggered. At operation 1816, the model 1850 provides suggestions and a score (e.g., quality score). The suggestions may be based on the process 1700 (shown in FIG. 17) for the final suggestions (e.g., at operation 1714). The model 1850 may receive the diff details (e.g., at operation 1812) and generate suggestions for the code reviewer. Prior to providing the suggestions, the model 1850 provides a score of the overall diff review (e.g., published diff review at operation 1802). The score of the diff review may be based on a variety of factors, such as functionality and correctness, maintainability and extensibility, edge handling cases, absence of bugs, performance, error handling, testability, and code duplication. The functionality and correctness may include ensuring the code meets the requirements and works as intended. The maintain ability and extensibility may include a determination whether the code is easy to understand, modify and scale. The edge case handling may include certain scenarios to ensure the code works in many, if not all, possible situations. The absence of bugs may include the identification and fixing of defects that may cause unexpected behavior. Performance may include optimization of code execution time and resource consumption. Error handling may include dealing with errors and providing useful feedback. Testability may include writing testable code that allows for effective verification. Code duplication may include avoiding repetition to reduce complexity and improve maintainability.

Based on the score, the model 1850 may provide the generated suggestions or forgo providing suggestions. For example, if the score is at or above a threshold score (e.g., threshold quality score), then the model 1850 may forgo providing the suggestions as the diff code is of an acceptable quality, and any suggestion(s) that would otherwise be provided are not necessary to implement to change the code. Put another way, the model 1850 may determine, based on a comparison between the score of the diff review and the threshold score, the diff review is of an acceptable quality.

Conversely, if the score is below the threshold score, then the model 1850 may provide the suggestions. At operation 1818, the suggestions are appended to the diff review. At operation 1820, the suggestions are accepted. The accepted suggestions may be from manual suggestions (e.g., from the manual review at operation 1806), from the model 1850 (provided the suggestions are generated due to the score), or a combination thereof. Further, the accepted suggestions may be provided as published diff review at operation 1802, allowing the coder to review the suggestions. At operation 1822, the accepted suggestions are loaded and the diff is complete.

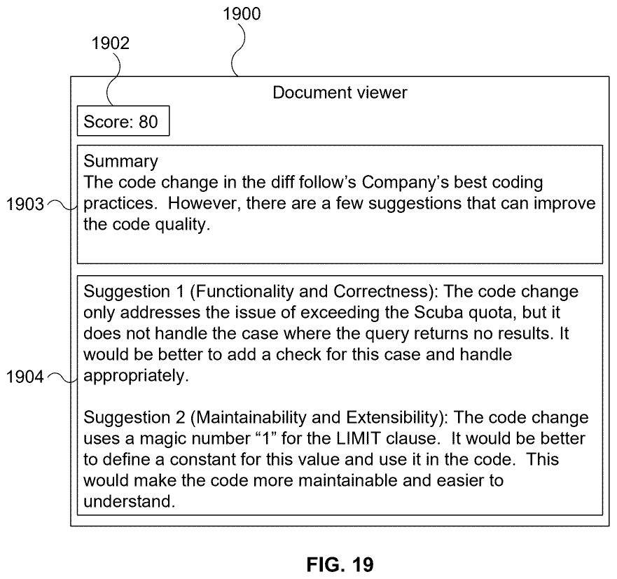

FIG. 19 illustrates an example of an output 1900 from a model (e.g., model 1850 shown in FIG. 18), in accordance with aspects of the present disclosure. The output 1900 may include a score 1902 corresponding to a quality score of diff code (e.g., from operation 1822 shown in FIG. 18), which may be presented on a display (e.g., of an electronic device 1600 shown in FIG. 16). As an example, the diff review received a score of 80. When the score 1902 is less than a threshold score (e.g., 85), a model may generate a summary 1903 and suggestions 1904. The summary 1903 may include a message (e.g., to the user) whether the code change in the diff follows a set of defined practices. The suggestions 1904 may be directed to a particular category. As non-limiting examples, the suggestions 1904 may include a suggestion directed to functionality and correctness, as well as to maintainability and extensibility. The output 1900 from the model may be viewed by the coder as feedback for improving the computer code. In one or more implementations, the suggestions 1904 may be used to automatically update the computer code. Put another way, a computing system may use the suggestions 1904 to update the computer code without human input or approval.

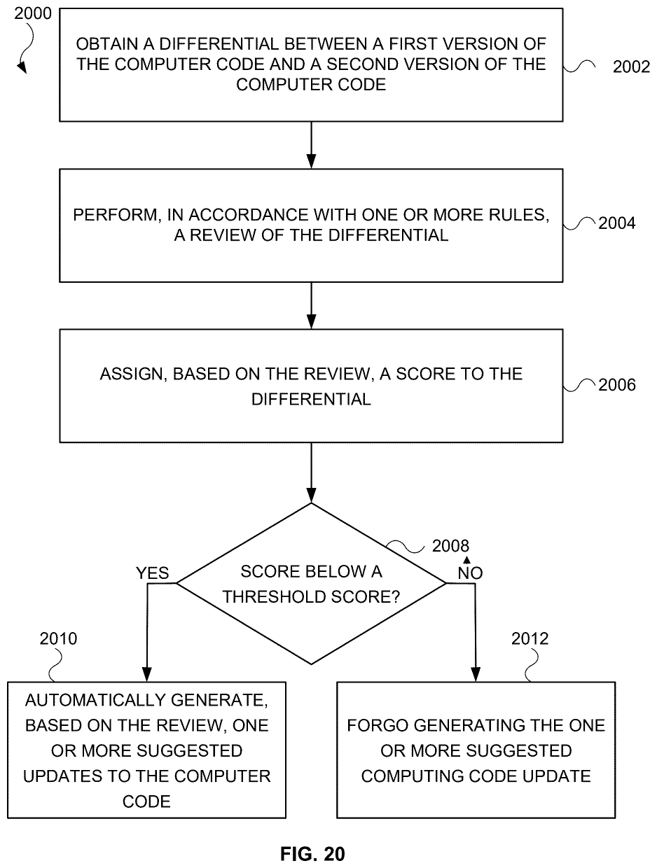

FIG. 20 illustrates an example flowchart showing a process 2000 for diff review of computer code, in accordance with aspects of the present disclosure. The process 2000 may be carried by a model, including a trained model (e.g., MLM, trained network model). At operation 2002, obtaining a differential between a first version of the computer code and a second version of the computer code is obtained by a version control system such as Git/Mercurial. At operation 2004, in accordance with one or more rules, a review of the differential is performed. At operation 2006, based on the review, a score is assigned to the differential. At operation 2008, a decision is made whether the score is below a threshold score. If the score is less below (e.g., less than) the threshold score, then at operation 2010, based on the review, one or more suggested updates to the computer code are automatically generated. If the score is not less than (e.g., above greater than) the threshold score, then at operation 2012, the process 2000 will forgo generating the one or more suggested computing code updates.

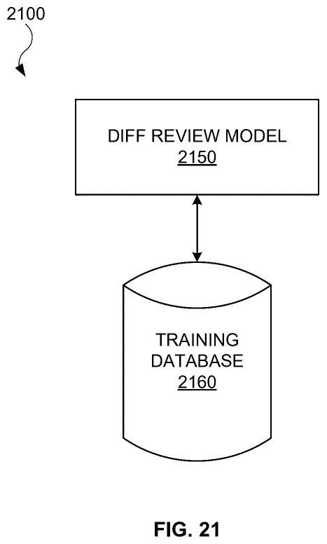

FIG. 21 illustrates an example of a machine learning framework 2100 including diff review model 2150 and training database 2160, in accordance with one or more examples of the present disclosure. The machine learning framework 2100 may be hosted locally in a computing device or hosted remotely. The training database 2160 may include several tasks (e.g., code drafting tasks, self-supervised diff review learning tasks, quality of diff review tasks etc.). Using the training database 2160, the machine learning framework 2100 may train the diff review model 2150 to translate received text from one language to another, or vice versa or from one use case to another. The diff review model 2150 may be stored computing device. For example, the diff review model 2150 may reside within a computing system, such as a portable electronic device, a head-mounted display, a server, or the like.

The training database 2160 may include a plurality of training datasets, which may include one or more diff review datasets and one or more quality scoring datasets. Each of the one or more diff review datasets and the one or more quality scoring datasets may include labeled and/or unlabeled data. Diff reviews may be labeled as including a quality score. The labeled training datasets may be used, for example, to train a diff review model, such as the diff review model 2150. The unlabeled training datasets may be used, for example, to validate the training. The training database 2160 employed by the machine learning framework 2100 may be fixed or updated periodically.

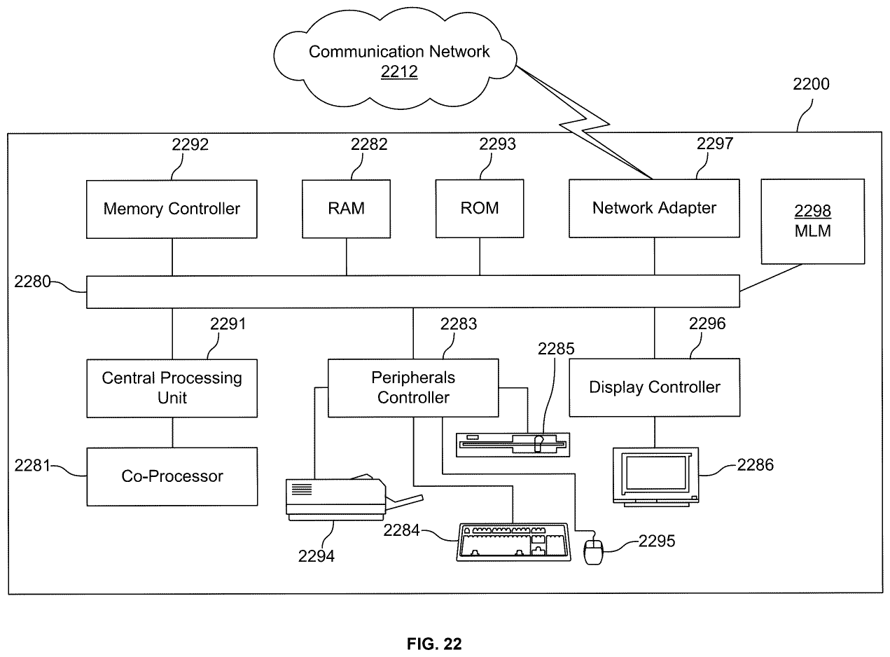

FIG. 22 is a block diagram of an example of a computing system 2200. The computing system 2200 may include an MLM 2298. The computing system 2200 may comprise a computer or server and may be controlled primarily by computer readable instructions, which may be in the form of software, wherever, or by whatever means such software is stored or accessed. Such computer readable instructions may be executed within a processor, such as central processing unit 2291, or CPU, to cause computing system 2200 to operate. In many workstations, servers, and personal computers, the central processing unit 2291 may be implemented by a single-chip CPU called a microprocessor. In other machines, the central processing unit 2291 may comprise multiple processors. Coprocessor 2281 may be an optional processor, distinct from main CPU 2291, that performs additional functions or assists CPU 2291.

In operation, the central processing unit 2291 fetches, decodes, and executes instructions, and transfers information to and from other resources via the computer's main data-transfer path, the system bus 2280. The system bus 2280 may connect the components in computing system 2200 and defines the medium for data exchange. The system bus 2280 typically includes data lines for sending data, address lines for sending addresses, and control lines for sending interrupts and for operating the system bus. An example of such the system bus 2280 is the Peripheral Component Interconnect (PCI) bus.

Memories coupled to the system bus 2280 include RAM 2282 and ROM 2293. Such memories may include circuitry that allows information to be stored and retrieved. ROM 2293 generally contain stored data that cannot easily be modified. Data stored in RAM 2282 may be read or changed by the central processing unit 2291 or other hardware devices. Access to RAM 2282 and/or ROM 2293 may be controlled by a memory controller 2292. The memory controller 2292 may provide an address translation function that translates virtual addresses into physical addresses as instructions are executed. The memory controller 2292 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, the computing system 2200 may contain a peripherals controller 2283 responsible for communicating instructions from the central processing unit 2291 to peripherals, such as a printer 2294, a keyboard 2284, mouse 795, and a disk drive 2285.

A display 2286, which is controlled by a display controller 2296, may be used to display visual output generated by computing system 2200. Such visual output may include text, graphics, animated graphics, and video. The display 2286 may also include or be associated with a user interface. The user interface may be capable of presenting one or more content items and/or capturing input of one or more user interactions associated with the user interface. The display 2286 may be implemented with a cathode-ray tube (CRT)-based video display, a liquid-crystal display (LCD)-based flat-panel display, gas plasma-based flat-panel display, or a touch-panel. The display controller 2296 includes electronic components required to generate a video signal that is sent to the display 2286.

Further, the computing system 2200 may contain communication circuitry, such as for example a network adaptor 2297, that may be used to connect the computing system 2200 to an external communications network, such as a communication network 2212, to enable the computing system 700 to communicate with other nodes (e.g., electronic devices such as smartphones or tablet compute devices, servers, MR devices) connected to the network.

The MLM 2298 may receive one or more requests for content from a device (e.g., an electronic device, server, MR device). In response to receipt of such a request(s) from the device, the MLM 2298 may provide automated diff review of computer code to be presented to a user of the device, including one or more suggestions (e.g., suggested updates) and a score (e.g., quality score of the diff code). In some examples, the MLM 2298 may be pre-trained, trained in real-time, and/or periodically trained with training data (e.g., from the training database 2160 shown in FIG. 21) to determine scoring of and/or suggestions for diff code based in part on receipt of the request(s) from the device.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

### D. Machine Learning Models Associated With Customer Surveys

### Technological Field

The present invention relates generally to electronic messaging and more particularly to the methods or computer program systems for the delivery of customer satisfaction surveys on social media platforms.

### Background

The present invention relates generally to electronic messaging and more particularly to the methods or computer program systems for the delivery of customer satisfaction surveys on social media platforms.

### Summary

The disclosed subject matter provides methods or computer program systems for optimizing the delivery of customer satisfaction surveys to a social media user account available on any accessible device. In various examples, customer satisfaction surveys are delivered only to select social media accounts that are deduced via machine learning algorithm to optimize the outreach of the survey and maximize results while not compromising user experience.

In one aspect, a method includes receiving, at a server, a survey to be delivered to a sample of user accounts; determining which user accounts are targets of the survey; delivering the survey to the sample of user accounts; and receiving survey responses associated with a subset of the sample of user accounts.

In another aspect, the server analyzes the population of user accounts' historical responses to the surveys; predicts responses for user accounts based on the user account's historical responses; creates a smaller subset of the population of user accounts to sample the survey based on their historical responses; assesses the responses from the sample of user accounts in light of the algorithmically-generated predictions to measure the accuracy of the machine learning model; and calibrates the machine learning model to create pertinent samples customized to survey content.

A method and computer program system for selectively delivering customer satisfaction surveys to samples of user accounts within a social media platform that may optimize the survey responses and user experience is provided. Customer satisfaction surveys are delivered only to subsets of the population of the social media platform that are deduced via a machine learning algorithm that analyzes historical responses to surveys to determine which user accounts will be the most effective and efficient use of platform resources.

### Detailed Description

Social media platforms often use randomized sampling to distribute customer satisfaction surveys, aiming to maximize responses through high-volume outreach. However, this approach can lead to repeated surveys sent to the same users, potentially causing survey fatigue and diminishing the quality of responses.

To address this issue, there is a need for an intelligent survey optimization system. Such a system would strategically select user accounts most likely to provide valuable feedback, ensuring efficient and effective communication of survey objectives while minimizing the number of recipients for maximum impact.

The disclosed subject matter may intelligently route surveys to designated user accounts that have been derived from analysis of historical responses to previous surveys and other interactions with the social media platform. The system may minimize survey fatigue, yield more relevant results associated with the survey, or enhance the user experience.

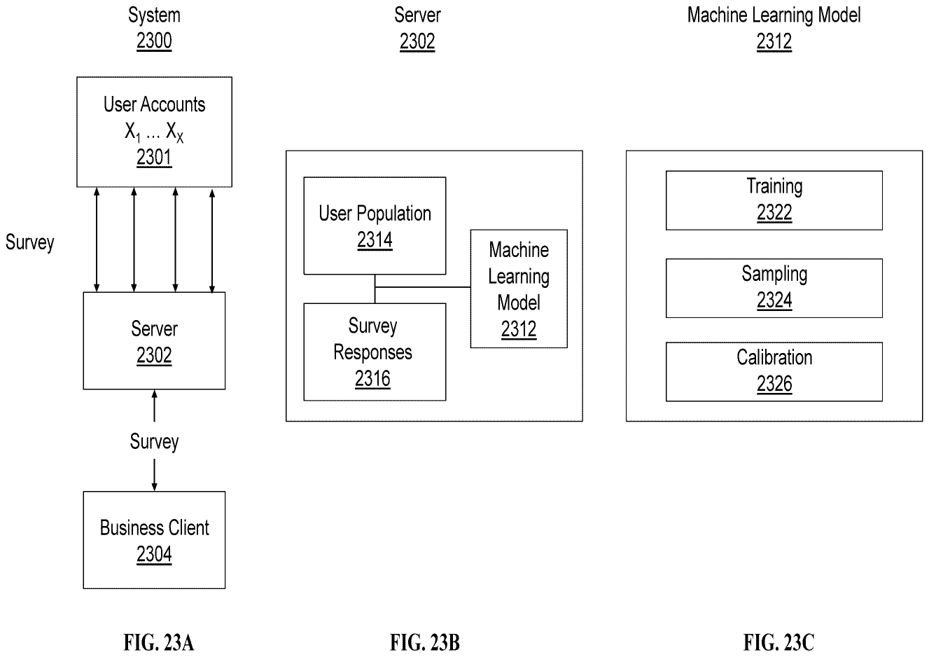

FIG. 23A illustrates an exemplary system 2300 for implementing the disclosed subject matter. The system 2300 may include a server 2302 connected with the population of social media platform user accounts 2301. Server 2302 may be connected with a business client 2304. Business client 2304 may send the survey to server 2302 for it to distribute the survey appropriately to a sample of user accounts 2301 based on the machine learning model 2312. The sample of user accounts 2301 may be associated with the same social media platform and may belong to different people on the platform. These user accounts may communicate with the server 2302 via a communications network.

As shown in FIG. 23B, the server 2302 includes a machine learning model 2312, a database of user accounts on the social media platform 2314, or a database of survey responses 2316. The machine learning model 2312 may be responsible intelligently routing surveys only to designated user accounts by assessing historical survey responses from the population of user accounts, determining which user accounts have a pattern of responding to the surveys in a thoughtful or curious manner, or routing the survey appropriately. To be flagged as a target for the survey, the user account may have a history of responding to surveys with thoughtful responses or, if the survey is simply a numerical rating, to consistently be grading their user experience between two and four stars out of five, for example. The database of user accounts on the social media platform 2314 may store user account information and device associations. User account information may consist of the associated devices attached to the one user account, the login information, the profile information of the owner of the user account, etc. The database of historical survey responses 116 may store past surveys and responses from previous surveys from all user accounts. Customer survey responses may vary in format, but responses are typically in numerals. It is contemplated herein that one or more of the functionalities described herein may be one device or module or distributed over multiple devices or modules.

As shown in FIG. 23C, the machine learning model 2312 includes a training module 2322, a sampling module 2324, or a calibration module 2326. The training module 2322 may be responsible evaluating all historical responses of surveys from the database of survey responses 2316 and extracting statistical patterns and evaluations correlating survey responses to user accounts. The sampling module 2324 may be responsible for assessing the entire population of user accounts on the social media platform from the database of user accounts on the social media platform 2314 and using machine learning algorithms to predict survey responses for the entire population by sending out surveys to smaller samples of user accounts within the population. The calibration module 2326 may be responsible for comparing the machine learning model 2312's predicted survey responses to the actual-in-fact survey responses from the smaller samples of user accounts and mapping responses against predictions. The calibration module 2326 is continuously assessing and reassessing the accuracy of the machine learning module 2312.

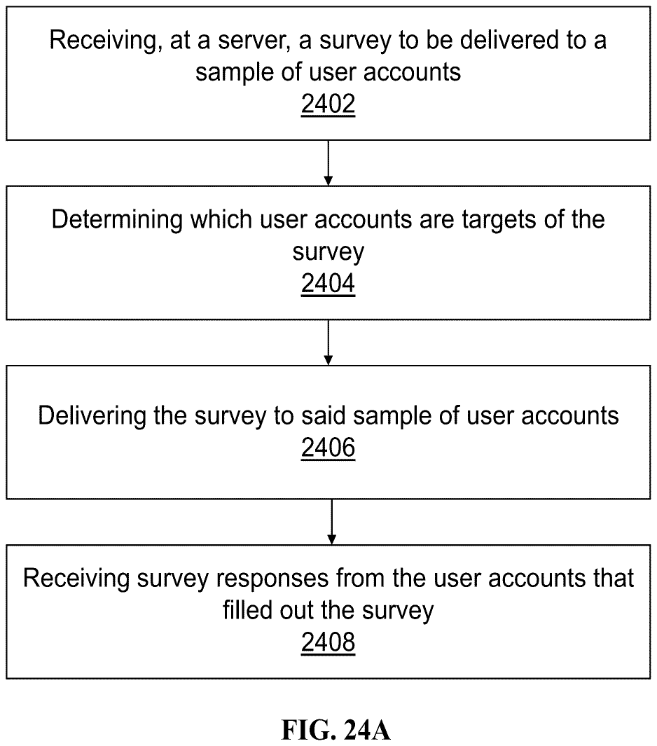

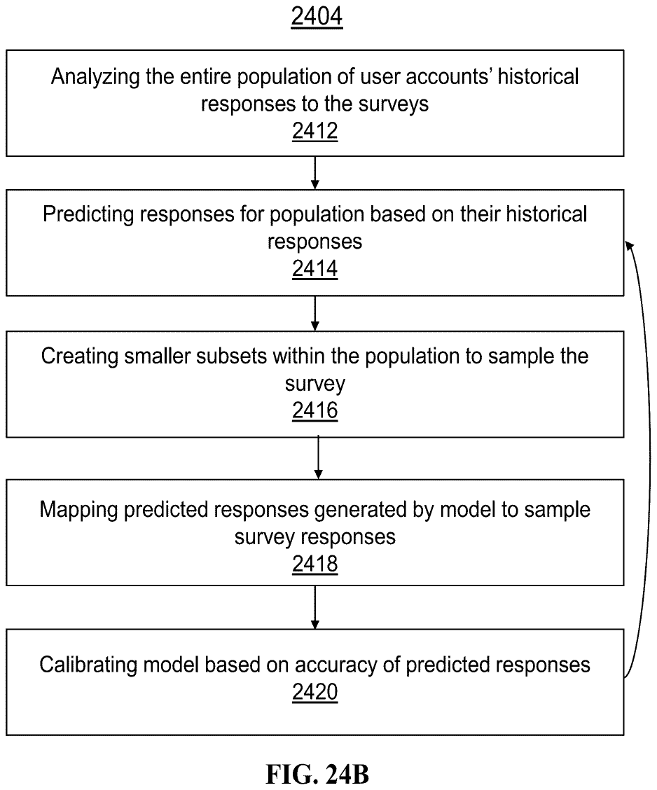

FIG. 24A illustrates a method 2400 for processing and delivering surveys from a server perspective. At step 2402, the server 2302 may receive a survey to be delivered to a sample of user accounts 2301. The survey may be created by the business client 2304 and/or its marketing or technology team. The survey may concern a variety of topics (e.g., usability of the social media platform, preference in advertisements, suggestions for additions to the platform, frequency by which the user account uses the platform, etc.) and may vary in length and format. In step 2404, the server 2302 may determine which user accounts 2301 are targets of the specific survey. This determination may be based on various factors, which may be assessed by the machine learning model 2312. The factors may include user demographic (e.g., age and/or gender), prior engagement with the platform, or engagement with and quality of previous responses to prior surveys.

Upon the derivation of the appropriate sample, the server 2302 may deliver the survey at step 2406 to the sample of user accounts 2301. The user accounts may be associated with the same social media platform and may belong to different people on the platform. One user account may be linked to any number of user devices (e.g., smartphones, tablets, computers, etc.). The server 2302 then receives survey responses associated with the user accounts that are connected with filled out the survey at step 2408. It is contemplated that other devices may execute some or all of the disclosed steps herein.

FIG. 24B further illustrates the processes that may occur at step 2404, in which the server determines which user accounts of the population of user accounts 2301 are targets of the survey. Step 2412 illustrates training of the machine learning model 2312, by which the machine learning model 2312 analyzes the entire population of user accounts' historical responses to some or all surveys sent out by the social media platform 2316. Step 2412 may occur once. Upon training of the machine learning model 2312, the machine learning model 2312 may predict responses for the population of user accounts 2301 based on their historical responses 2316 in step 2414. These predictions may derive smaller subsets within the population, which may become the target sample for the survey in step 2416. The server 2302 may send out surveys to the derived sample in step 2416, and in step 2417, the machine learning model 2312 may map its predicted response for the sample with the actual-in-fact responses received by user accounts within the sample in step 2418. Upon mapping in step 2418, the machine learning model 2312 may assess its accuracy and calibrate accordingly in step 2420. Calibration 2420 may occur regularly, as the machine learning model 2312 may continuously become more accurately with more training data and more samples.

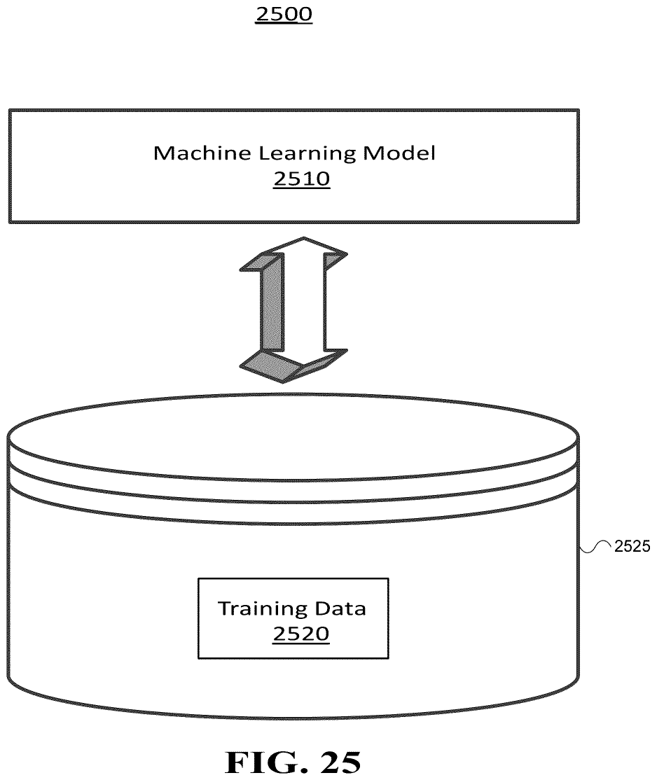

FIG. 25 illustrates a framework 2500 associated with machine learning and/or artificial intelligence (AI). The framework 2500 may be hosted remotely. Alternatively, the framework 2500 may reside within the system 2300 shown in FIG. 23A and may be processed/implemented by a device. In some examples, the machine learning model 2510 (also referred to herein as artificial intelligence model 2510) may be implemented/executed by the server (e.g., server 2302). In other examples, the machine learning model 2510 may be implemented/executed by the machine learning model 2312 in the server 2302 and other devices (e.g., user accounts 2301). The machine learning model 2510 may be operably coupled with the stored training data in a training database 2525 (e.g., a database of user accounts on the social media platform 2314 or a database of survey responses 2316). In some examples, the machine learning model 2510 may be associated with other operations. The machine learning model 2510 may be one or more machine learning models.

In another example, the training data 2520 may include attributes of thousands of objects. For example, the objects may be user accounts on a social media platform, login information, responses to a survey from social media platform, and/or the like. Attributes may include but are not limited to the size, shape, orientation, position of the object(s), etc. The training data 2520 employed by the machine learning model 2510 may be fixed or updated periodically. Alternatively, the training data 2520 may be updated in real-time based upon the evaluations performed by the machine learning model 2510 in a non-training mode. This is illustrated by the double-sided arrow connecting the machine learning model 2510 and stored training data 2520.

The machine learning model 2510 may be designed to generate one or more responses to survey questions from the social media business client 2304 associated with one or more received inputs, based in part on utilizing determined contextual information. This information includes fields like a description, variables defined, data category associated with the variables and the output (e.g., survey responses), and responses to generated prompts. The machine learning model 2510 may be a large language model to generate representations (e.g., vector spaces), or embeddings, of one or more of the one or more inputs received. These machine learning model 2510 may be trained (e.g., pretrained and/or trained in real-time) on a vast amount of textual data (e.g., associated with the one or more inputs), previous responses to one or more prompts generated, previously distributed surveys, and/or data capture of a wide range of language patterns and semantic meanings. The machine learning model 2510 may understand and represent the context of words, terms, phrases and/or the like in a high-dimensional space, effectively capturing/determining the semantic similarities between different received inputs, including descriptions and responses to prompts, even when they are not exactly the same.

Typically, such predictions by some existing systems may require a large quantity of manual annotation(s) and/or brute force computer-based annotation to obtain the training data in a supervised training framework. However, example aspects of the present disclosure may deploy a machine learning model(s) (e.g., machine learning model 2510) that may be flexible, adaptive, automated, temporal, learns quickly and trainable. Manual operations or brute force device operations may be unnecessary for the examples of the present disclosure due to the learning framework aspects of the present disclosure that are implementable by the machine learning model 2510. As such, this enables one or more user inputs, requests for programmable code to solve one or more problems, or other aspects of the examples of the present disclosure to be flexible and scalable to billions of users, and their associated communication devices, on a network device.

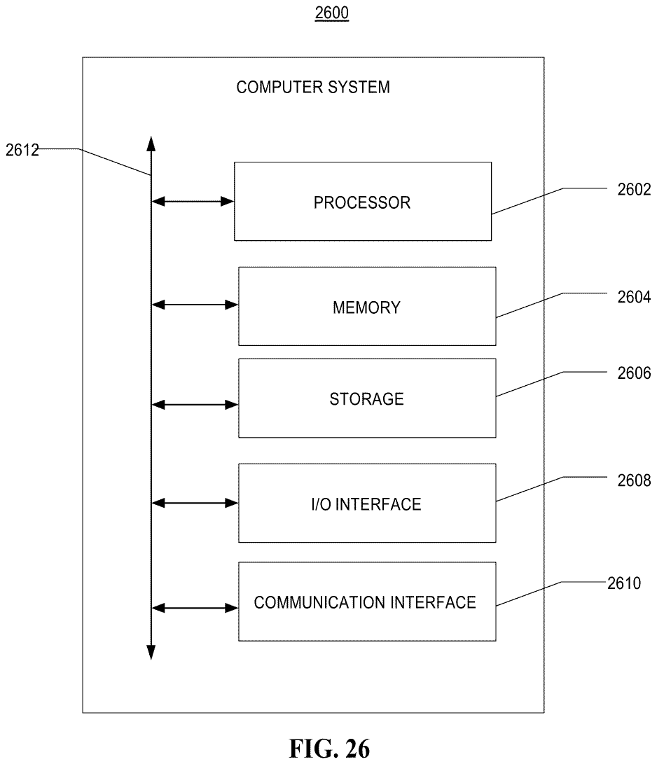

FIG. 26 illustrates an example computer system 2600. In examples, one or more computer systems 2600 perform one or more steps of one or more methods described or illustrated herein. In particular embodiments, one or more computer systems 2600 provide functionality described or illustrated herein. In examples, software running on one or more computer systems 2600 performs one or more steps of one or more methods described or illustrated herein or provides functionality described or illustrated herein. Examples include one or more portions of one or more computer systems 2600. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 2600 taking any suitable physical form. As example and not by way of limitation, computer system 2600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 2600 may include one or more computer systems 2600; be unitary or distributed; span multiple locations; span multiple machines; span multiple data centers; or reside in a cloud, which may include one or more cloud components in one or more networks. Where appropriate, one or more computer systems 2600 may perform without substantial spatial or temporal limitation one or more steps of one or more methods described or illustrated herein. As an example, and not by way of limitation, one or more computer systems 2600 may perform in real time or in batch mode one or more steps of one or more methods described or illustrated herein. One or more computer systems 2600 may perform at different times or at different locations one or more steps of one or more methods described or illustrated herein, where appropriate.

In examples, computer system 2600 includes a processor 2602, memory 2604, storage 2606, an input/output (I/O) interface 2608, a communication interface 2610, and a bus 2612. Although this disclosure describes and illustrates a particular computer system having a particular number of particular components in a particular arrangement, this disclosure contemplates any suitable computer system having any suitable number of any suitable components in any suitable arrangement.

In examples, processor 2602 includes hardware for executing instructions, such as those making up a computer program. As an example, and not by way of limitation, to execute instructions, processor 2602 may retrieve (or fetch) the instructions from an internal register, an internal cache, memory 2604, or storage 2606; decode and execute them; and then write one or more results to an internal register, an internal cache, memory 2604, or storage 2606. In particular embodiments, processor 2602 may include one or more internal caches for data, instructions, or addresses. This disclosure contemplates processor 2602 including any suitable number of any suitable internal caches, where appropriate. As an example, and not by way of limitation, processor 2602 may include one or more instruction caches, one or more data caches, and one or more translation lookaside buffers (TLBs). Instructions in the instruction caches may be copies of instructions in memory 2604 or storage 2606, and the instruction caches may speed up retrieval of those instructions by processor 2602. Data in the data caches may be copies of data in memory 2604 or storage 406 for instructions executing at processor 2602 to operate on; the results of previous instructions executed at processor 2602 for access by subsequent instructions executing at processor 2602 or for writing to memory 2604 or storage 2606; or other suitable data. The data caches may speed up read or write operations by processor 2602. The TLBs may speed up virtual-address translation for processor 2602. In particular embodiments, processor 2602 may include one or more internal registers for data, instructions, or addresses. This disclosure contemplates processor 2602 including any suitable number of any suitable internal registers, where appropriate. Where appropriate, processor 2602 may include one or more arithmetic logic units (ALUs); be a multi-core processor; or include one or more processors 2602. Although this disclosure describes and illustrates a particular processor, this disclosure contemplates any suitable processor.

In examples, memory 2604 includes main memory for storing instructions for processor 2602 to execute or data for processor 2602 to operate on. As an example, and not by way of limitation, computer system 2600 may load instructions from storage 2606 or another source (such as, for example, another computer system 2600) to memory 2604. Processor 2602 may then load the instructions from memory 2604 to an internal register or internal cache. To execute the instructions, processor 2602 may retrieve the instructions from the internal register or internal cache and decode them. During or after execution of the instructions, processor 2602 may write one or more results (which may be intermediate or final results) to the internal register or internal cache. Processor 2602 may then write one or more of those results to memory 2604. In particular embodiments, processor 2602 executes only instructions in one or more internal registers or internal caches or in memory 2604 (as opposed to storage 2606 or elsewhere) and operates only on data in one or more internal registers or internal caches or in memory 2604 (as opposed to storage 2606 or elsewhere). One or more memory buses (which may each include an address bus and a data bus) may couple processor 2602 to memory 2604. Bus 2612 may include one or more memory buses, as described below. In examples, one or more memory management units (MMUs) reside between processor 2602 and memory 2604 and facilitate accesses to memory 2604 requested by processor 2602. In particular embodiments, memory 2604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 2604 may include one or more memories 2604, where appropriate. Although this disclosure describes and illustrates particular memory, this disclosure contemplates any suitable memory.

In examples, storage 2606 includes mass storage for data or instructions. As an example, and not by way of limitation, storage 2606 may include a hard disk drive (HDD), a floppy disk drive, flash memory, an optical disc, a magneto-optical disc, magnetic tape, or a Universal Serial Bus (USB) drive or a combination of two or more of these. Storage 2606 may include removable or non-removable (or fixed) media, where appropriate. Storage 2606 may be internal or external to computer system 2600, where appropriate. In examples, storage 2606 is non-volatile, solid-state memory. In particular embodiments, storage 2606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 2606 taking any suitable physical form. Storage 2606 may include one or more storage control units facilitating communication between processor 2602 and storage 2606, where appropriate. Where appropriate, storage 2606 may include one or more storages 2606. Although this disclosure describes and illustrates particular storage, this disclosure contemplates any suitable storage.

In examples, I/O interface 2608 includes hardware, software, or both, providing one or more interfaces for communication between computer system 2600 and one or more I/O devices. Computer system 2600 may include one or more of these I/O devices, where appropriate. One or more of these I/O devices may enable communication between a person and computer system 2600. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 2608 for them. Where appropriate, I/O interface 2608 may include one or more device or software drivers enabling processor 2602 to drive one or more of these I/O devices. I/O interface 2608 may include one or more I/O interfaces 2608, where appropriate. Although this disclosure describes and illustrates a particular I/O interface, this disclosure contemplates any suitable I/O interface.

In examples, communication interface 2610 includes hardware, software, or both providing one or more interfaces for communication (such as, for example, packet-based communication) between computer system 2600 and one or more other computer systems 2600 or one or more networks. As an example, and not by way of limitation, communication interface 2610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 2610 for it. As an example, and not by way of limitation, computer system 2600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 2600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 2610 for any of these networks, where appropriate. Communication interface 2610 may include one or more communication interfaces 2610, where appropriate. Although this disclosure describes and illustrates a particular communication interface, this disclosure contemplates any suitable communication interface.

In particular embodiments, bus 2612 includes hardware, software, or both coupling components of computer system 2600 to each other. As an example and not by way of limitation, bus 2612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 2612 may include one or more buses 2612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, computer readable medium or any suitable combination of two or more of these, where appropriate. A computer-readable non-transitory storage medium may be volatile, non-volatile, or a combination of volatile and non-volatile, where appropriate.

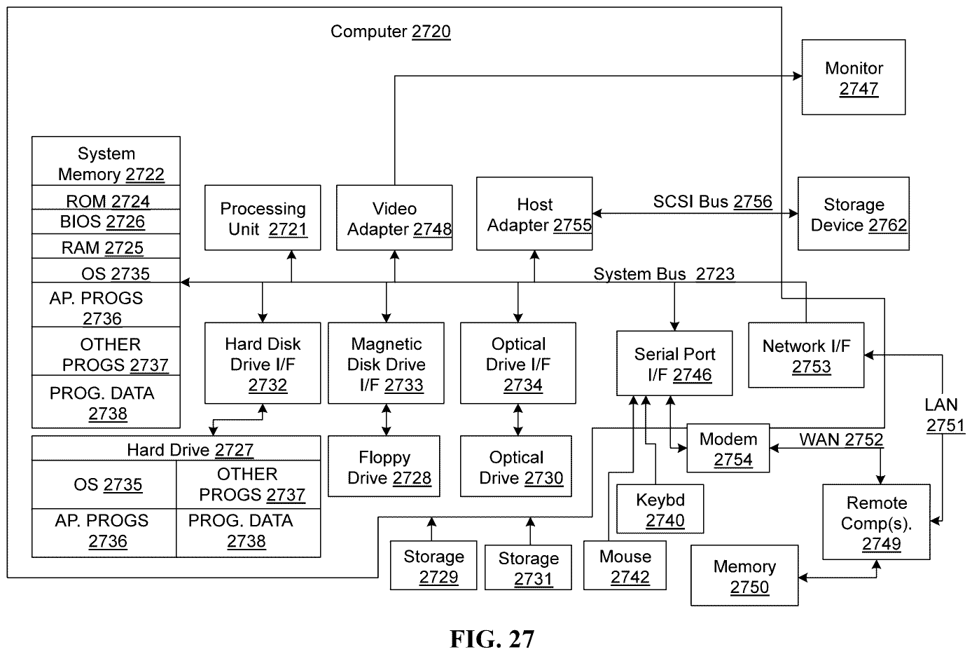

FIG. 27 and the following discussion are intended to provide a brief general description of a suitable computing environment in which the methods and systems disclosed herein and/or portions thereof may be implemented. Although not required, the methods and systems disclosed herein is described in the general context of computer-executable instructions, such as program modules, being executed by a computer, such as a client workstation, server, personal computer, or mobile computing device such as a smartphone. Generally, program modules include routines, programs, objects, components, data structures and the like that perform particular tasks or implement particular abstract data types. Moreover, it should be appreciated the methods and systems disclosed herein and/or portions thereof may be practiced with other computer system configurations, including hand-held devices, multi-processor systems, microprocessor-based or programmable consumer electronics, network PCs, minicomputers, mainframe computers and the like. The methods and systems disclosed herein may also be practiced in distributed computing environments where tasks are performed by remote processing devices that are linked through a communications network. In a distributed computing environment, program modules may be located in both local and remote memory storage devices.

FIG. 27 is a block diagram representing a general purpose computer system in which aspects of the methods and systems disclosed herein and/or portions thereof may be incorporated. As shown, the exemplary general purpose computing system includes a computer 2720 or the like, including a processing unit 2721, a system memory 2722, and a system bus 2723 that couples various system components including the system memory to the processing unit 2721. The system bus 2723 may be any of several types of bus structures including a memory bus or memory controller, a peripheral bus, and a local bus using any of a variety of bus architectures. The system memory includes read-only memory (ROM) 2724 and random access memory (RAM) 2725. A basic input/output system 2726 (BIOS), containing the basic routines that help to transfer information between elements within the computer 2720, such as during start-up, is stored in ROM 2724.

The computer 2720 may further include a hard disk drive 2727 for reading from and writing to a hard disk (not shown), a magnetic disk drive 2728 for reading from or writing to a removable magnetic disk 2729, and an optical disk drive 2730 for reading from or writing to a removable optical disk 2731 such as a CD-ROM or other optical media. The hard disk drive 2727, magnetic disk drive 2728, and optical disk drive 2730 are connected to the system bus 2723 by a hard disk drive interface 2732, a magnetic disk drive interface 2733, and an optical drive interface 2734, respectively. The drives and their associated computer-readable media provide non-volatile storage of computer readable instructions, data structures, program modules and other data for the computer 2720. As described herein, computer-readable media is an article of manufacture and thus not a transient signal.

Although the exemplary environment described herein employs a hard disk, a removable magnetic disk 2729, and a removable optical disk 2731, it should be appreciated that other types of computer readable media which can store data that is accessible by a computer may also be used in the exemplary operating environment. Such other types of media include, but are not limited to, a magnetic cassette, a flash memory card, a digital video or versatile disk, a Bernoulli cartridge, a random access memory (RAM), a read-only memory (ROM), and the like.

A number of program modules may be stored on the hard disk, magnetic disk 2729, optical disk 2731, ROM 2724 or RAM 2725, including an operating system 2735, one or more application programs 2736, other program modules 2737 and program data 2738. A user may enter commands and information into the computer 2720 through input devices such as a keyboard 540 and pointing device 2742. Other input devices (not shown) may include a microphone, joystick, game pad, satellite disk, scanner, or the like. These and other input devices are often connected to the processing unit 2721 through a serial port interface 2746 that is coupled to the system bus, but may be connected by other interfaces, such as a parallel port, game port, or universal serial bus (USB). A monitor 2747 or other type of display device is also connected to the system bus 2723 via an interface, such as a video adapter 2748. In addition to the monitor 2747, a computer may include other peripheral output devices (not shown), such as speakers and printers. The exemplary system of FIG. 27 also includes a host adapter 2755, a Small Computer System Interface (SCSI) bus 2756, and an external storage device 2762 connected to the SCSI bus 2756.

The computer 2720 may operate in a networked environment using logical connections to one or more remote computers, such as a remote computer 2749. The remote computer 2749 may be a personal computer, a server, a router, a network PC, a peer device or other common network node, and may include many or all of the elements described above relative to the computer 2720. The logical connections depicted in FIG. 27 include a local area network (LAN) 2751 and a wide area network (WAN) 2752. Such networking environments are commonplace in offices, enterprise-wide computer networks, intranets, and the Internet.

When used in a LAN networking environment, the computer 2720 is connected to the LAN 2751 through a network interface or adapter 2753. When used in a WAN networking environment, the computer 2720 may include a modem 2754 or other means for establishing communications over the wide area network 2752, such as the Internet. The modem 2754, which may be internal or external, is connected to the system bus 2723 via the serial port interface 2746. In a networked environment, program modules depicted relative to the computer 2720, or portions thereof, may be stored in the remote memory storage device. It will be appreciated that the network connections shown are exemplary and other means of establishing a communications link between the computers may be used.

Computer 2720 may include a variety of computer readable storage media. Computer readable storage media can be any available media that can be accessed by computer 2720 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 2720. Combinations of any of the above should also be included within the scope of computer readable media that may be used to store source code for implementing the methods and systems described herein. Any combination of the features or elements disclosed herein may be used in one or more examples. The terms machine learning (ML), deep learning, or artificial intelligence (AI) may be used interchangeably herein.

Additionally, contrary to conventional computing systems that use central processing units (CPUs), in some examples the disclosed connected fly light system(s) may primarily use graphics processing units (GPUs), field-programmable gate arrays (FPGAs), or application-specific integrated circuits (ASICs), which may be referenced herein as AI chips, for executing the disclosed methods. Unlike CPUs, AI chips may have optimized design features that may dramatically accelerate the identical, predictable, independent calculations required by AI applications or AI algorithms. These algorithms may include executing a large number of calculations in parallel rather than sequentially, as in CPUs; calculating numbers with low precision in a way that successfully implements AI applications or AI algorithms but reduces the number of transistors needed for the same calculation(s); speeding up memory access by, for example, storing an entire AI application or AI algorithm in a single AI chip; or using programming languages built specifically to efficiently translate AI computer code for execution on an AI chip.

The machine learning model 2312 exercised by the server 2302 analyzes the database of user accounts 2314 and the database of historical survey responses 2316, as illustrated in FIG. 23B. This training, sampling, and calibration process is an example of the AI chip's programming to create a more detailed calculation and produce more accurate results. Different types of AI chips are useful for different tasks. GPUs may be used for initially developing and refining AI applications or AI algorithms; this process is known as “training.” FPGAs may be used to apply trained AI applications or AI algorithms to real-world data inputs; this is often called “inference.” ASICs may be designed for either training or inference. The server may exercise a machine learning model 2312 using expansive datasets, which may encompass a social media platform's user account data and historical responses from customer satisfaction surveys.

The scope of this disclosure encompasses all changes, substitutions, variations, alterations, and modifications to the example embodiments described or illustrated herein that a person having ordinary skill in the art would comprehend. The scope of this disclosure is not limited to the examples described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
training a first model to recognize a gesture in a first input modality; and
using the training of the first model to recognize the gesture in the first input modality to train a second model in a second input modality to recognize the gesture.

2. A computing device for visualizing artificial intelligence (AI) operations, comprising:
a processor; and
a memory coupled to the processor, the memory comprising instructions that when executed by the processor cause the processor to effectuate operations comprising:
receiving a request from a user to perform an AI operation;
monitoring a plurality of tasks associated with the AI operation;
publishing status events associated with the monitored tasks;
receiving the status events; and
sending instructions to render a graphical visualization displaying real-time status of the plurality of tasks, wherein the graphical visualization comprises a radar graph with different regions representing different types of tasks and different colors representing different task states.

3. The computing device of claim 2, wherein the different task states comprise:
a requested state indicated by a first color;
an in-progress state indicated by a second color; or
a completed state indicated by a third color.

4. The computing device of claim 2, wherein the different types of tasks comprise:
text processing tasks;
voice processing tasks;
structured data processing tasks;
unstructured data processing tasks;
file handling tasks; or
image processing tasks.

5. The computing device of claim 2, wherein the operations further comprise:
aggregating task status data over predetermined time intervals; and
updating the graphical visualization at the predetermined time intervals with aggregated task status data.

6. The computing device of claim 2, wherein the operations further comprise:
detecting a user device associated with the user;
determining display capabilities of the user device; and
adapting the graphical visualization based on the display capabilities.

7. The computing device of claim 2, wherein the operations further comprise:
filtering the status events based on a user identifier associated with the request; and
displaying status events associated with the user identifier in the graphical visualization.

8. The computing device of claim 2, wherein rendering the graphical visualization comprises displaying numerical indicators showing quantities of tasks in a respective state for a respective task type.

9. A method comprising:
obtaining, by a training model, a differential between a first version of computer code and a second version of the computer code;
performing, by the training model, in accordance with one or more rules, a review of the differential;
assigning, by the training model, based on the review, a score to the differential; and
automatically generating by the training model, based on the review, one or more suggested updates to the computer code in response to the score being below a threshold score.

10. The method of claim 9, further comprising:
prior to obtaining the review, obtaining a request to at least a portion of the differential.

11. The method of claim 9, wherein the score comprises a quality score of the differential.

12. The method of claim 11, wherein the quality score is based on or more changes to the computer code in the differential.

13. The method of claim 11, wherein the quality score is based on one or more of a testability or a maintainability of the computer code.

14. The method of claim 9, in response to the score being at or above the threshold score, forgo generating the one or more suggested computing code updates.

15. The method of claim 9, further comprising:
automatically generating, based on the review, a summary of the differential in response to the score being below the threshold score.

16. The method of claim 9, further comprising:
providing, to a display, the one or more suggested computing code updates.

17. The method of claim 9, further comprising:
receiving, at a server, a customer satisfaction survey to be delivered to a sample of user accounts on a social media platform;
determining which user accounts are targets of the survey;
delivering the survey to the sample of user accounts; and
receiving survey responses associated with a subset of the sample of user accounts.

18. The method of claim 17, wherein the social media platform sends the server a customer satisfaction survey.

19. The method of claim 17, wherein the customer satisfaction survey may require rating user experience on a scale from one to five.

20. The method of claim 17, wherein the determining which user accounts are targets of the survey uses a machine learning model.
